(19) United States
(12) Patent Application Publication
(10) Pub. No.: US 2020/0135110 A1
(43) Pub. Date: Apr. 30, 2020

(54) DISPLAY DEVICE AND DRIVING METHOD THEREFOR

(71) Applicant: Sharp Kabushiki Kaisha, Sakai City, Osaka (JP)

(72) Inventors: Makoto YOKOYAMA, Sakai City (JP); Masahiro MITANI, Sakai City (JP); Tamotsu SAKAI, Sakai City (JP); Fumiyuki KOBAYASHI, Sakai City (JP)

(21) Appl. No.: 16/493,369

(22) PCT Filed: Mar. 24, 2017
(86) PCT No.: PCT/JP2017/012123

§ 371 Date: Sep. 12, 2019

(51) Int. Cl. G09G 3/3258; G09G 3/3266; G09G 3/3275

(52) U.S. Cl. CPC G09G 3/3258; G09G 3/3266; G09G 2310/0297; G09G 2300/0452; G09G 3/3275

(57) ABSTRACT

The present application discloses an organic EL display device adopting the SSD method, which enables sufficient charging with a data voltage and sufficient internal compensation in a pixel circuit even in a case that a display image has a higher resolution. There are provided m demultiplexers corresponding to m sets of data signal line groups, each of which is a set including k data signal lines (in this case, k=2). Each demultiplexer simultaneously turns selection control signals at a low level (active) during a reset period before a scanning signal line is selected. In this case, a white voltage is supplied as a reset voltage from a data-side drive circuit to each data signal line via each demultiplexer. After that, during the select period for the scanning signal line, each demultiplexer sequentially switches, with the selection control signals, a data signal line to which the data signal is to be supplied from the data-side drive circuit among corresponding k data signal lines.

### TECHNICAL FIELD

The disclosure relates to a display device, more specifically, to a display device including a display element driven by a current such as an organic Electro Luminescence (EL) display device, and a driving method of the display device.

### BACKGROUND ART

An organic EL display device has been known as a thin-type, high picture quality, and low power consumption display device. In the organic EL display device, arranged in a matrix are a plurality of pixel circuits including organic EL elements (also referred to as “organic light emitting diodes”) that are self-luminous type display elements driven by current, drive transistors, and the like.

As one of the driving methods of various display devices such as an organic EL display device, a driving method has been known in which driving signals generated by a data-side drive circuit (hereinafter, also referred to as a “data driver”) are demultiplexed and supplied to the predetermined number, that is two or more, of data signal lines (source line) (hereinafter, referred to as a “source shared driving (SSD) method”) in a display unit. FIG. 15 is a circuit diagram illustrating a connection relationship between pixel circuits and various wiring lines in an organic EL display device adopting the SSD method disclosed in PTL 1. The organic EL display device adopting the SSD method (hereinafter, referred to as a “first known example”) performs color display of RGB three-primary colors. There are provided m×k×n pixel circuits 11 corresponding to intersections between m×k data lines (each of m and k is an integer equal to or more than 2) and n scanning lines (n is an integer equal to or more than 2). In the present specification, a pixel circuit corresponding to “R” (red) is referred to as a “R pixel circuit,” and is denoted by the reference symbol “11r.” Further, a pixel circuit corresponding to “G” (green) is referred to as a “G pixel circuit,” and is denoted by the reference symbol “11g.” Further, a pixel circuit corresponding to “B” (blue) is referred to as a “B pixel circuit,” and is denoted by the reference symbol “11b.”

Respective m output lines Di (i=1 to m) connected to output terminals of a data driver (not illustrated) correspond to m demultiplexers 41. Each output line Di corresponding to each demultiplexer 41 is connected to three data lines Dri, Dgi, and Dbi with three selecting transistors Mr, Mg, and Mb interposed therebetween, respectively, included in the demultiplexer 41. The selecting transistors Mr, Mg, and Mb all are P-channel type transistors. The selecting transistors Mr, Mg, and Mb correspond to R, G, and B, respectively. The selecting transistor Mr turns to an on state in response to a selection control signal SSDr in a case that a data signal corresponding to R (hereinafter, referred to as a “R data signal”) is to be supplied to the data line Dri. The selecting transistor Mg turns to an on state in response to a selection control signal SSDg in a case that a data signal corresponding to G (hereinafter, referred to as a “G data signal”) is to be supplied to the data line Dgi. The selecting transistor Mb turns to an on state in response to a selection control signal SSDb in a case that a data signal corresponding to B (hereinafter, referred to as a “B data signal”) is to be supplied to the data line Dbi. Hereinafter, the selecting transistors Mr, Mg, and Mb are referred to as a “R selecting transistor,” a “G selecting transistor,” and a “B selecting transistor,” respectively. Further, the selection control signals SSDr, SSDg, and SSDb are referred to as a “R selection control signal,” a “G selection control signal,” and a “B selection control signal,” respectively. Further, the data lines Dri, Dgi, and Dbi are referred to as a “R data line,” a “G data line,” and a “B data line,” respectively. The data signal output from the data driver is divided in time division by the respective demultiplexers 41, and is supplied to the R data line Dri, the G data line Dgi, and the B data line Dbi in the stated order, which are connected to the demultiplexers 41. Adopting the SSD method like this can reduce a circuitry scale of the data driver.

In the first known example (the organic EL display device disclosed in PTL 1), as illustrated in FIG. 15, data capacitors Cdri, Cdgi, and Cdbi for holding a voltage of the data signal (hereinafter, also referred to as a “data voltage”) are connected to the R data line Dri, the G data line Dgi, and the B data line Dbi, respectively. Hereinafter, the data capacitors Cdri, Cdgi, and Cdbi are referred to as a “R data capacitor,” a “G data capacitor,” and a “B data capacitor,” respectively. Each pixel circuit 11 includes one organic EL element OLED, six transistors M1 to M6, and two capacitors C1 and C2. The transistors M1 to M6 all are P-channel type transistors. The transistor M1 is a drive transistor for controlling a current to be supplied to the organic EL element OLED. The transistor M2 is a writing transistor for writing a voltage of a data signal (data voltage) into the pixel circuit. The transistor M3 is a compensating transistor for compensating variation in a threshold voltage of the drive transistor M1 which causes a luminance unevenness. The transistor M4 is an initialization transistor for initializing a gate voltage Vg of the drive transistor M1. The transistor M5 is a power-supplying transistor for controlling the supply of the high-level power source voltage ELVDD to the pixel circuit 11. The transistor M6 is a light emission control transistor for controlling a light emission period of the organic EL element OLED. The capacitors C1 and C2 are capacitors for holding a source-gate voltage Vgs of the drive transistor M1. In each of the R pixel circuit 11r, the G pixel circuit 11g, and the B pixel circuit 11b, the gate terminal of the writing transistor M2 is connected to a scanning line Sj along each of the R pixel circuit 11r, the G pixel circuit 11g, and the B pixel circuit 11b.

FIG. 16 is a timing chart illustrating a driving method of the pixel circuit illustrated in FIG. 15. From a time t1 to a time t2, the initialization transistor M4 is in the on state so that the gate voltage Vg of the drive transistor M1 is initialized. From the time t2 to a time t3, a R data signal is supplied to the R data line Dri, and a voltage of the R data signal is held in the R data capacitor Cdri. From the time t3 to a time t4, a G data signal is supplied to the G data line Dgi, and a voltage of the G data signal is held in the G data capacitor Cdgi. From the time t4 to a time t5, a B data signal is supplied to the B data line Dbi, and a voltage of the B data signal is held in the B data capacitor Cdbi. At the time t5, in each of the R pixel circuit 11r, the G pixel circuit 11g, and the B pixel circuit 11b, the writing transistor M2 and the compensating transistor M3 turns to the on state so that the data voltage is supplied to the gate terminal of the drive transistor M1 via the writing transistor M2, the drive transistor M1, and the compensating transistor M3. At this time, the drive transistor M1 turns to a diode-connected state, and the gate voltage Vg of the drive transistor M1 is obtained by Equation (1) below.

Vg=Vdata−Vth (1)

where Vdata is the data voltage, and Vth is the threshold voltage of the drive transistor M1.

At a time t6, the writing transistor M2 and the compensating transistor M3 turn to an off state, and the power-supplying transistor M5 and the light emission control transistor M6 turn to the on state. For this reason, a drive current I expressed by Equation (2) below is supplied to the organic EL element OLED so that the organic EL element OLED emits light according to a current value of the drive current I.

I=(β/2)·(Vgs−Vth)² (2)

where, 13 represents a constant, and Vgs represents a source-gate voltage of the drive transistor M1. The source-gate voltage Vgs of the drive transistor M1 is obtained by Equation (3) below.

Vgs=ELVDD−Vg . . . =ELVDD−Vdata+Vth (3)

Equation (4) below is derived from Equation (2) and Equation (3).

I=β/2·(ELVDD−Vdata)² (4)

In Equation (4), a term of the threshold voltage Vth is absent. For this reason, the variation in the threshold voltage Vth of the drive transistor M1 is compensated. In this way, in the first known example, the variation in the threshold voltage of the drive transistor is compensated by a configuration in the pixel circuit (hereinafter, the compensation of the threshold voltage of the drive transistor in the above-mentioned manner is referred to as an “internal compensation”). Note that, it has been known that the longer a period Tcomp is set during which the threshold voltage Vth is compensated by putting the drive transistor M1 into the diode-connected state, the more the variation in the threshold voltage Vth of the drive transistor M1 is suppressed.

### CITATION LIST

### Patent Literature

PTL 1: JP 2007-79580 A

PTL 2: JP 2008-158475 A

PTL 3: JP 2007-286572 A

### SUMMARY

### Technical Problem

In the first known example (the organic EL display device disclosed in PTL 1) described above, the R data signal, the G data signal, and the B data signal are sequentially supplied to the R data line Dri, the G data line Dgi, and the B data line Dbi, respectively. Further, as illustrated in FIG. 15, a connection destination of the gate terminal of the writing transistor M2 is the scanning line Sj in any of the R pixel circuit 11r, the G pixel circuit 11g, and the B pixel circuit 11b. For this reason, when the scanning line Sj is in a select state before starting any of the supply of the R data signal to the R data line Dri, the supply of the G data signal to the G data line Dgi, and the supply of the B data signal to the B data line Dbi, any of the voltage supplied from the R data line Dri, the G data line Dgi, and the B data line Dbi may not be able to be written into the capacitor C1.

For example, as illustrated in FIG. 17, when the scanning line Sj is in the select state (the scanning signal is in the low level) before starting the supply of the R data signal to the R data line Dri, a voltage of the R data signal (hereinafter, referred to as the “R data voltage in last scanning”) which is supplied to the R data line Dri when a preceding scanning line Sj-1 is selected is written into the capacitor C1 via the drive transistor M1. As is seen from FIG. 15, when the scanning line Sj is in the select state, the R data line Dri is electrically connected to the capacitor C1 via the drive transistor M1 in the diode-connected state. For this reason, in a case where the voltage of the R data signal (hereinafter, referred to as the “R data voltage in present scanning”) which is supplied to the R data line Dr when the scanning line Sj is in the select state is lower than the R data voltage in last scanning, the R data voltage in present scanning cannot be written into the capacitor C1. For example, in a case where the R data voltage in last scanning is a voltage corresponding to a luminance close to a minimum luminance (black display), the voltage corresponding to a luminance closed to the minimum luminance, that is, a voltage close to a maximum value is written into the capacitor C1 in the R pixel circuit 11r from when the scanning line Sj is selected to when the selecting transistor Mr in the demultiplexer 41 is turned on (from when a signal of the scanning line Sj changes to the low level to when the selection control signal SSDr changes to the low level) as illustrated in FIG. 17. For this reason, when a voltage corresponding to a relatively high luminance, that is, a voltage Vd2 sufficiently smaller than a maximum value Vd1 is applied as the R data voltage in present scanning to the R pixel circuit 11r, the drive transistor M1 in the R pixel circuit 11r turns to the off state, and a voltage of the capacitor C1 thereof (the gate voltage Vg of the drive transistor M1) is maintained as a voltage Vng2 at a voltage close to the maximum value.

In order to avoid such problem (hereinafter, referred to as a “a data writing failure caused by such a diode-connection”), the first known example described above is configured such that, as illustrated in FIG. 16, the scanning line Sj is in a non-select state during a data write period during which the R, G, and B data signals are supplied to the R, G, and B data lines Drj, Dgj, and Dbj, respectively, and after the data write period elapses, the scanning line Sj turns to the select state (the low level in the example in FIG. 16).

In this way, in the first known example described above, the R, G, and B data signals are written into the R, G, and B pixel circuits, respectively, by turning the scanning line Sj to the select state after the R, G, and B data signals are sequentially written into the R, G, and B data lines Drj, Dgj, and Dbj on the basis of the SSD method. Specifically, in the organic EL display device using the SSD method in which the diode-connection is used to perform internal compensation as in the first known example, gray scale data (data voltage) indicated by those data signals cannot be written into the pixel circuits unless sequential writing of the data signals into a data signal line group such a set of R, G, and B data lines Drj, Dgj, and Dbj is completed. For this reason, the writing of the gray scale data into the pixel circuit, that is, the charging of the data voltage to the data-holding capacitor C1 in the pixel circuit may not be performed sufficiently. In a case where a horizontal interval is shortened with improvement in high resolution of a display image in recent years, a period for writing the data into the data signal line and a select period of the scanning line in the horizontal interval are also shortened, and therefore, such charge shortage is particularly problematic. In a case that the select period of the scanning line is shortened, the luminance unevenness also cannot be sufficiently suppressed by compensating the variation in the threshold voltage of the drive transistor in each pixel circuit.

With regard to this point, an organic EL display device described in, for example, PTL 2 (an organic electroluminescence display device) (hereinafter, referred to as a “second known example”) is configured to perform internal compensation while adopting the SSD method similarly to the first known example illustrated in FIG. 15, and uses a drive method as illustrated in FIG. 18. This driving method involves, at a data programing stage, a data line initialization stage Sdi in which the data lines are initialized by lowering the voltages of the data lines Dri, Dgi, and Dbi. Specifically, with the circuit configuration illustrated in FIG. 15 as a premise, as illustrated in FIG. 18, the data line initialization stage Sdi is started at a time is after data signals Rdn, Gdn, and Bdn are supplied to the pixel circuits 11r, 11g, and 11b via the data lines Dri, Dgi, and Dbi, respectively, by sequentially turning the selecting transistors (switching elements) Mr, Mg, and Mb of the demultiplexer 41 to the on state in response to the selection control signals SSDr, SSDg, and SSDb. With this driving method, the data lines Dri, Dgi, and Dbi are initialized by initialization data signals Ri, Gi, and Bi, respectively, before the selecting transistors Mr, Mg, and Mb are turned off during the select period of the last scanning line Sj-1 before the select period of the present scanning line Sj (the low-level period in FIG. 18) during which data signals Rdn, Gdn, and Bdn are supplied to the data lines Dri, Dgi, and Dbi, respectively.

In the second known example described above, while avoiding the problem illustrated in FIG. 17, that is, the data writing failure caused by such a diode-connection, the period during which writing of the data voltage into the pixel circuit and compensation of the threshold voltage Vth of the drive transistor are performed can be increased as compared the first known example described above (see FIG. 16 and FIG. 18). However, as illustrated in FIG. 18, the three data line initialization stages Sdi are included in each horizontal interval (1 H periods) during which the scanning line is in the select state. Thus, in a case that a display image has a higher resolution, even the second known example described above cannot sufficiently solve problems such as insufficient charge of the data voltage and insufficient time for the internal compensation in the pixel circuit.

Therefore, it has been desired to provide an organic EL display device adopting the SSD method, which enables sufficient charging of a data voltage and sufficient internal compensation in a pixel circuit even in a case that a display image has a higher resolution.

### Solution to Problem

According to embodiments of the disclosure, a display device, including a plurality of data signal lines configured to transmit a plurality of analog voltage signals indicating an image to be displayed, a plurality of scanning signal lines intersecting the plurality of data signal lines, a plurality of pixel circuits arranged in a matrix shape along the plurality of data signal lines and the plurality of scanning signal lines. The display device further includes a data-side drive circuit including a plurality of output terminals respectively corresponding to a plurality sets of data signal line groups that are obtained by dividing the plurality of data signal lines into groups, each of which is a set including a two or more predetermined number of data signal lines, configured to output, in time division from each of the plurality of output terminals, a predetermined number of analog voltage signals to be each transmitted by the predetermined number of data signal lines of a set corresponding to each of the output terminals, a plurality of demultiplexers respectively connected to the plurality of output terminals of the data-side drive circuit, and respectively correspond to the plurality sets of data signal line groups, a scanning-side drive circuit configured to selectively drive the plurality of scanning signal lines, and a display control circuit configured to control the plurality of demultiplexers, the data-side drive circuit, and the scanning-side drive circuit. Each of the plurality of demultiplexers includes a predetermined number of switching elements respectively corresponding to the predetermined number of data signal lines in a corresponding set, respectively, and each of the predetermined number of switching elements includes a first conduction terminal connected to a corresponding data signal line, a second conduction terminal configured to receive an analog voltage signal output by the data-side drive circuit from an output terminal of the plurality of output terminals connected to a demultiplexer of the plurality of demultiplexers, and a control terminal configured to receive a selection control signal for controlling on and off states. Each of the plurality of pixel circuits corresponds to any one of the plurality of data signal lines and corresponds to any one of the plurality of scanning signal lines. Each of the plurality of pixel circuits includes a display element configured to be driven by a current, a holding capacitance configured to hold a voltage for controlling a drive current for the display element, and a drive transistor configured to supply, to the display element, the drive current in accordance with the voltage held in the holding capacitance, and is configured such that in a case that a corresponding scanning signal line is in a select state, the drive transistor is in a diode-connected state, and a voltage of a corresponding data signal line is supplied to the holding capacitance via the drive transistor. The display control circuit simultaneously turns the predetermined number of switching elements to an on state during a reset period provided, for a scanning signal line of the plurality of scanning signal lines, after a preceding scanning signal line is changed to a non-select state and before the scanning signal line is selected, the preceding scanning signal line being another scanning signal line of the plurality of scanning signal lines selected immediately before the scanning signal line is selected, and sequentially turns the predetermined number of switching elements to the on state for a predetermined period after the reset period and before the scanning signal line is changed from the select state to the non-select state such that at least one switching element of the predetermined number of switching elements turns to the on state during a select period for each of the plurality of scanning signal lines. The data-side drive circuit, during the reset period, outputs a voltage for initializing each of the plurality of data signal lines as a reset voltage from each of the plurality of output terminals, and after the reset period, outputs the predetermined number of analog voltage signals in time division from each of the plurality of output terminals in accordance with control of the display control circuit that sequentially turns the predetermined number of switching elements to the on state for the predetermined period.

According to embodiments of the disclosure, a driving method of a display device including a plurality of data signal lines configured to transmit a plurality of analog voltage signals indicating an image to be displayed, a plurality of scanning signal lines intersecting the plurality of data signal lines, and a plurality of pixel circuits arranged in a matrix shape along the plurality of data signal lines and the plurality of scanning signal lines. The display device further includes a data-side drive circuit including a plurality of output terminals respectively corresponding to a plurality sets of data signal line groups that are obtained by dividing the plurality of data signal lines into groups, each of which is a set including a two or more predetermined number of data signal lines, and a plurality of demultiplexers respectively connected to the plurality of output terminals of the data-side drive circuit, and corresponding to the plurality sets of data signal line groups, respectively. Each of the plurality of demultiplexers includes a predetermined number of switching elements corresponding to the predetermined number of data signal lines in the corresponding set, respectively. Each of the predetermined number of switching elements includes a first conduction terminal connected to a corresponding data signal line, a second conduction terminal configured to receive an analog voltage signal output by the data-side drive circuit from an output terminal of the plurality of output terminals connected to a demultiplexer of the plurality of demultiplexers, and a control terminal configured to receive a selection control signal for controlling on and off states. Each of the plurality of pixel circuits corresponding to any one of the plurality of data signal lines and corresponds to any one of the plurality of scanning signal lines. Each of the plurality of pixel circuits includes a display element configured to be driven by a current, a holding capacitance configured to hold a voltage for controlling a drive current for the display element, and a drive transistor configured to supply, to the display element, the drive current in accordance with the voltage held in the holding capacitance, and each of the plurality of pixel circuits being configured such that in a case that a corresponding scanning signal line is in a select state, the drive transistor is in a diode-connected state, and a voltage is supplied from the corresponding data signal line to the holding capacitance via the drive transistor. The method includes a scanning-side driving step of selectively driving the plurality of scanning signal lines, a reset step of simultaneously turning the predetermined number of switching elements to an on state during a reset period provided, for a scanning signal line of the plurality of scanning signal lines, after a preceding scanning signal line is changed to a non-select state and before the scanning signal line is selected, the preceding scanning signal line being another scanning signal line of the plurality of scanning signal lines selected immediately before the scanning signal line is selected, a demultiplex step of sequentially turning the predetermined number of switching elements to the on state for a predetermined period after the reset period and before the scanning signal line is changed from the select state to the non-select state such that at least one switching element of the predetermined number of switching elements is the on state during a select period for each of plurality of the scanning signal lines, a reset voltage output step of outputting a voltage for initializing each of the data signal lines as a reset voltage from each of the plurality of output terminals of the data-side driver circuit during the reset period, and a data signal output step of outputting, in time division from each of the plurality of output terminals of the data-side drive circuit, the predetermined number of analog voltage signals to be transmitted to the predetermined number of data signal lines in the set corresponding to each of the plurality of output terminals after the reset period, in accordance with the demultiplex step of sequentially turning the predetermined number of switching elements to the on state for the predetermined period.

### Advantageous Effects of Disclosure

In the embodiments of the disclosure described above, the SSD method is adopted. For a scanning signal line of the plurality of scanning signal lines, the predetermined number of switching elements in each of the demultiplexers simultaneously turn to an on state during the reset period provided after the preceding scanning signal line, which is selected immediately before the scanning signal line is selected, is changed to the non-select state and before the scanning signal line is selected. During the reset period, the voltage for initializing the data signal line is output as the reset voltage from the output terminal of the data-side drive circuit. After that, the predetermined number of switching elements in each of the demultiplexers sequentially turn to the on state for the predetermined period after the reset period and before the scanning signal line is changed from the select state to the non-select state such that at least one switching element among the predetermined number of switching elements in each of the demultiplexers is in the on state during the selection period for the scanning signal line of the plurality of scanning signal lines. With this, the predetermined number of analog voltage signals, which are output in time division from each output terminal of the data-side drive circuit, are sequentially supplied to the predetermined number of corresponding data signal lines via the corresponding demultiplexer. In this manner, according to the embodiments of the disclosure described above, before the select period for the scanning signal line of the plurality of scanning signal lines, and during the reset period provide before the analog voltage signal being the data signal is supplied to each of the data signal lines, each of the data signal lines is initialized. Thus, while avoiding the data writing failure caused by the diode-connection in the pixel circuit, the data period and the scanning select period overlap with each other. In this manner, without reducing the scanning select period, the data line charging period can be increased to a larger extent compared to the related art. With this, sufficient charging of the data voltage and sufficient internal compensation in the pixel circuit can be performed even in a case that a display image has a higher resolution.

### BRIEF DESCRIPTION OF DRAWINGS

FIG. 1 is a block diagram illustrating an overall configuration of a display device according to a first embodiment.

FIG. 2 is a circuit diagram illustrating a connection relationship between pixel circuits and various wiring lines in the first embodiment.

FIG. 3 is a signal waveform diagram illustrating a drive of the display device illustrated in FIG. 1 in a case where the display device adopts the known driving method.

FIG. 4 is a signal waveform diagram illustrating a drive of the display device according to the first embodiment.

FIG. 5 is a signal waveform diagram illustrating an operation of the display device illustrated in FIG. 1 in the case where the display device adopts the known driving method.

FIG. 6 is a signal waveform diagram illustrating an operation of the display device according to the present embodiment.

Each of FIG. 7A and FIG. 7B is a signal waveform diagram illustrating an operation of a display device in a modified example of the first embodiment.

FIG. 8 is a block diagram illustrating an overall configuration of a display device according to a second embodiment.

FIG. 9 is a circuit diagram illustrating a connection relationship between pixel circuits and various wiring lines in the second embodiment.

FIG. 10 is a signal waveform diagram illustrating a drive of the display device according to the second embodiment.

FIG. 11 is a signal waveform diagram illustrating an operation of the display device according to the second embodiment.

Each of FIG. 12A and FIG. 12B is a signal waveform diagram illustrating an operation of a display device in a modified example of the second embodiment.

FIG. 13 is a signal waveform diagram illustrating a display device in another modified example of each of the embodiments.

FIG. 14 is a signal waveform diagram illustrating a display device in further another modified example of each of the embodiments.

FIG. 15 is a circuit diagram illustrating a connection relationship between pixel circuits and various wiring lines in a first known example and a signal waveform diagram illustrating a problem.

FIG. 16 is a timing chart illustrating a driving method of the pixel circuit illustrated in FIG. 15.

FIG. 17 is a signal waveform diagram illustrating a problem in a known organic EL display device.

FIG. 18 is a signal waveform diagram illustrating a driving method in the second known example.

### DESCRIPTION OF EMBODIMENTS

In the following, each embodiment is described with reference to the accompanying drawings. Note that, in each of the transistors referred to below, the gate terminal corresponds to a control terminal, one of the drain terminal and the source terminal corresponds to a first conduction terminal, and the other corresponds to a second conduction terminal. Further, each of transistors in each embodiment is described as a P-channel type transistor, but the disclosure is not limited thereto. Furthermore, the transistor in each embodiment is, for example, a thin film transistor, but the disclosure is not limited thereto. Still further, the term “connection” used herein means “electrical connection” unless otherwise specified, and without departing from the spirit and scope of the disclosure, the term includes not only a case in which direct connection is meant but also a case in which indirect connection with another element therebetween is meant.

### 1. First Embodiment

### 1.1 Overall Configuration

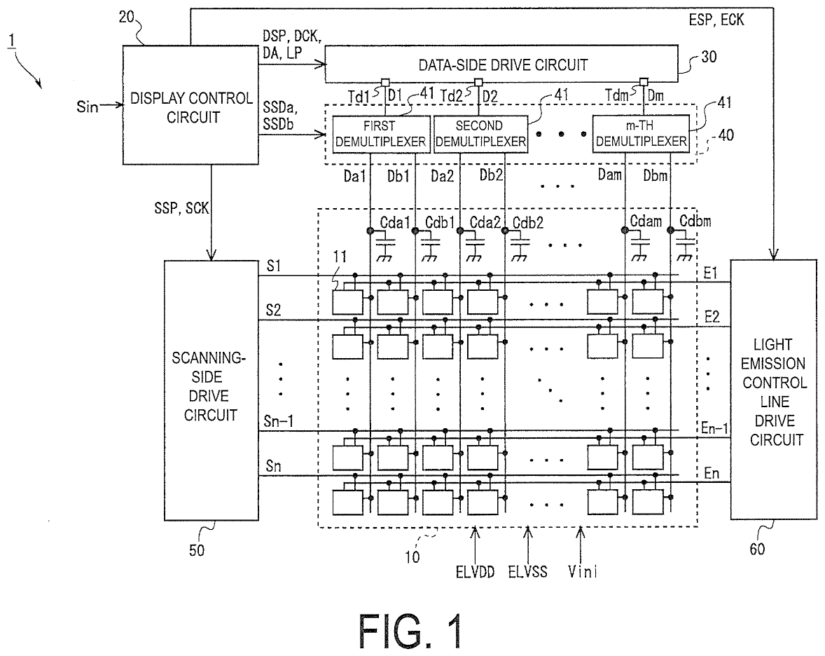

FIG. 1 is a block diagram illustrating an overall configuration of a display device 1 according to a first embodiment. This organic EL display device 1 is an organic EL display device adopting the SSD method for performing internal compensation, and as illustrated in FIG. 1, includes a display unit 10, a display control circuit 20, a data-side drive circuit (also referred to as a “data driver”) 30, a demultiplexer unit 40, a scanning-side drive circuit (also referred to as a “scanning driver”) 50, and a light emission control line drive circuit (also referred to as an “emission driver”) 60. In the present embodiment, the scanning-side drive circuit 50 and the light emission control line drive circuit 60 are formed so as to be integrated with the display unit 10 (this holds true in the other embodiments and the modified examples). However, the disclosure is not limited thereto.

In the display unit 10, m×k (m and k are integers of 2 or more, and k=2 in the present embodiment) data signal lines Da1, Db1, Da2, Db2, . . . , Dam, and Dbm and n scanning signal lines Si to Sn intersecting these data signal lines are disposed, and n light emission control lines (also referred to as “emission lines”) E1 to En are respectively disposed along the n scanning signal lines Si to Sn. Further, as illustrated in FIG. 1, the display unit 10 is provided with the 2m×n pixel circuits 11, and those 2m×n pixel circuits 11 are arranged in a matrix shape along the 2m data signal lines Dx1 to Dxm (x=a, b) and the n scanning signal lines S1 to Sn in such a manner that each of these 2m×n pixel circuits 11 corresponds to any one of the 2m data signal lines Dx1 to Dxm (x=a, b) and also corresponds to any one of the n scanning signal lines S1 to Sn and any one of the n light emission control lines E1 to En. The 2m data signal lines Dx1 to Dxm (x=a, b) are connected to the demultiplexer unit 40, the n scanning signal lines S1 to Sn are connected to the scanning-side drive circuit 50, and the n light emission control lines E1 to En are connected to the light emission control line drive circuit 60.

In addition, in the display unit 10, a power source line common to each pixel circuit 11 (not illustrated) is provided. To be more specific, a power source line (hereinafter, referred to as a “high-level power source line”, and designated by a reference sign “ELVDD” similarly to the high-level power supply voltage) for supplying the high-level power supply voltage ELVDD for driving the organic EL element described later and a power source line (hereinafter, referred to as a “low-level power source line” are disposed, and designated by a reference sign “ELVSS” similarly to the low-level power supply voltage) for supplying the low-level power supply voltage ELVSS for driving the organic EL element. Further, an initialization line (designated by a reference sign “Vini” similarly to the initialization voltage) for supplying the initialization voltage Vini for an initialization action described later is disposed. These voltages are supplied from a power source circuit (not illustrated).

In FIG. 1, each of the wiring line capacitances Cda1 to Cdam formed in the m data signal lines Da1 to Dam is illustrated as a capacitor, and each of the wiring line capacitances Cdb1 to Cdbm formed in the other m data signal lines Db1 to Dbm is illustrated as a capacitor (hereinafter, those wiring line capacitances Cdxi (x=a, b; i=1 to m) are referred to as “data line capacitances”). A ground voltage is applied to one end (on a side not connected to the data signal line Dxi) of each data line capacitance Cdxi, but the disclosure is not limited thereto.

The display control circuit 20 receives an input signal Sin including image information representing an image to be displayed and timing control information for image display from the outside of the display device 1, and on the basis of the input signal Sin, outputs various control signals to the data-side drive circuit 30, the demultiplexer unit 40, the scanning-side drive circuit 50, and the light emission control line drive circuit 60. More specifically, the display control circuit 20 outputs a data start pulse DSP, a data clock signal DCK, display data DA, and a latch pulse LP to the data-side drive circuit 30. The display control circuit 20 also outputs an A selection control signal SSDa and a B selection control signal SSDb to the demultiplexer unit 40. Furthermore, the display control circuit 20 outputs a scan start pulse SSP and a scan clock signal SCK to the scanning-side drive circuit 50. Furthermore, the display control circuit 20 outputs a light emission control start pulse ESP and a light emission control clock signal ECK to the light emission control line drive circuit 60.

The data-side drive circuit 30 includes an m-bit shift register, a sampling circuit, a latch circuit, m D/A converters, and the like, which are not illustrated. The shift register includes m bistable circuits cascade-connected with each other, transfers the data start pulse DSP supplied in the initial stage in synchronization with the data clock signal DCK, and outputs sampling pulses from each stage. In accordance with the output timing of the sampling pulses, the display data DA is supplied to the sampling circuit. The sampling circuit stores the display data DA in accordance with the sampling pulses. In a case that one line of the display data DA is stored in the sampling circuit, the display control circuit 20 outputs the latch pulse LP to the latch circuit. The latch circuit, when having received the latch pulse LP, retains the display data DA stored in the sampling circuit. The D/A converters are provided correspondingly to the m output lines D1 to Dm respectively connected to m output terminals Td1 to Tdm of the data-side drive circuit 30, convert the display data DA held in the latch circuit into data signals being analog voltage signals, and supply the obtained data signals to the output lines D1 to Dm. The display device 1 according to the present embodiment adopts the SSD method, and hence the A data signal and the B data signal are supplied to each of the output lines Di sequentially (in a time-division manner). Here, the A data signal is a data signal to be applied to odd-numbered data signal lines (hereinafter also referred to as “A data signal lines”) Da1 to Dam out of 2m data signal lines Dx1 to Dxm (x=a, b) in the display unit 10, and the B data signal is a data signal to be applied to even-numbered data signal lines (hereinafter also referred to as “B data signal lines”) Db1 to Dbm.

The demultiplexer unit 40 includes m demultiplexers 41 which are first to m-th demultiplexers 41 respectively corresponding to the m output terminals Td1 to Tdm of the data-side drive circuit 30. The input terminal of the i-th demultiplexer is connected to the corresponding output terminal Tdi of the data-side drive circuit 30 with the output line Di interposed therebetween (i=1 to m). The i-th demultiplexer 41 (i=1 to m) includes two output terminals, and these two output terminals are respectively connected to two data signal lines Dai and Dbi. The i-th demultiplexer 41 supplies the A data signal and the B data signal sequentially supplied from the output terminal Tdi of the data-side drive circuit 30 via the output line Di respectively to the A data signal line Dai and the B data signal line Dbi. The action of each demultiplexer 41 is controlled by the A selection control signal SSDa and the B selection control signal SSDb. With the SSD method, the number of output lines connected to the data-side drive circuit 30 can be halved as compared to the case where the SSD method is not adopted. Thus, the circuit scale of the data-side drive circuit 30 is reduced, and hence the manufacturing cost of the data-side drive circuit 30 can be reduced.

The scanning-side drive circuit 50 drives n scanning signal lines S1 to Sn. More specifically, the scanning-side drive circuit 50 includes a shift register, buffers, and the like (not illustrated). The shift register sequentially transfers the scan start pulse SSP in synchronization with the scan clock signal SCK. The scanning signal being the output from each stage of the shift register is supplied to the corresponding scanning signal line Sj (j=1 to n) via a buffer. The 2m pixel circuits 11 connected to the scanning signal line Sj are collectively selected by the active (low level) scanning signals.

The light emission control line drive circuit 60 drives n light emission control lines E1 to En. More specifically, the light emission control line drive circuit 60 includes a shift register, buffers, and the like (not illustrated). The shift register sequentially transfers the light emission control start pulse ESP in synchronization with the light emission control clock signal ECK. The light emission control signal being the output from each stage of the shift register is supplied to the corresponding light emission control line Ej (j=1 to n) via a buffer.

As illustrated in FIG. 1, the scanning-side drive circuit 50 is disposed on one end side of the display unit 10 (the left side of the display unit 10 in FIG. 1), and the light emission control line drive circuit 60 is disposed on the other end side of the display unit 10 (the right side of the display unit 10 in FIG. 1). However, in place of the above, both of the scanning-side drive circuit 50 and the light emission control line drive circuit 60 or a scanning-side drive circuit including a function of a light emission control line drive circuit may be disposed on any one of the one end side and the other end side of the display unit 10 (this holds true in the other embodiments and the modified examples).

1.2 Connection Relationship between Pixel Circuit and Various Wiring Lines

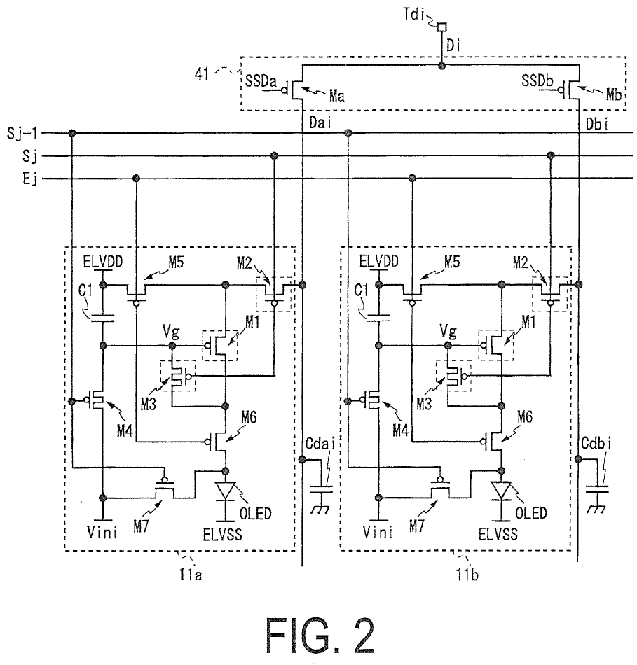

FIG. 2 is a circuit diagram illustrating a connection relationship between a part of pixel circuits 11a and 11b and various wiring lines in the present embodiment. Among the 2m×n pixel circuits 11 in the display unit 10, these pixel circuits 11a and 11b are connected to the same scanning signal line Sj, and are connected to the same demultiplexer 41 with the two data signal lines Dai and Dbi interposed therebetween. Here, the reference symbol “11a” is used to indicate the pixel circuit 11 connected to the A data signal line Dai (hereinafter, also referred to as an “A pixel circuit”), and the reference symbol “11b” is used to indicate the pixel circuit 11 connected to the B data signal line Dbi (hereinafter, also referred to as a “B pixel circuit”).

As illustrated in FIG. 2, each demultiplexer 41 includes an A selecting transistor Ma and a B selecting transistor Mb, and all of these selecting transistors Ma and Mb function as switching elements. An A selection control signal SSDa is supplied to the gate terminal as a control terminal of the A selecting transistor Ma, and a B selection control signal SSDb is supplied to the gate terminal as a control terminal of the B selecting transistor Mb. The drain terminals as first conduction terminals of these selecting transistors Ma and Mb are respectively connected to the data signal lines Dai and Dbi, and all of the source terminals as second conduction terminals of these selecting transistors Ma and Mb are connected to the output line Di (i=1 to m). Therefore, each output line Di is connected to the A data signal line Dai with the A selecting transistor Ma interposed therebetween and to the B data signal line Dbi with the B selecting transistor Mb interposed therebetween in the corresponding demultiplexer 41.

As illustrated in FIG. 2, the A pixel circuit 11a and the B pixel circuit 11b are sequentially arrayed in the extending direction of the scanning signal line. Note that, the configurations of the A pixel circuit 11a and the B pixel circuit 11b are basically the same. Thus, in the following, the parts common to one another in these pixel circuits are described by taking the configuration of the A pixel circuit 11a as an example, and the parts different from one another in these pixel circuits are described individually as appropriate.

The A pixel circuit 11a includes an organic EL element OLED, a drive transistor M1, a writing transistor M2, a compensating transistor M3, a first initialization transistor M4, a power-supplying transistor M5, a light emission control transistor M6, and a second initialization transistor M7, and a data-holding capacitor C1 as a holding capacitance configured to hold a data voltage. The drive transistor M1 includes a gate terminal, a first conduction terminal, and a second conduction terminal. In the present embodiment, dual-gate transistors are used for the compensating transistor M3 and the first initialization transistor M4 in order to reduce an off-leak current, but normal single-gate transistors may be used. Note that the B pixel circuit 11b also includes elements similar to those of the A pixel circuit 11a, and the connection relationship between the elements of the B pixel circuit 11b is also the same as that of the A pixel circuit 11a.

To the A pixel circuit 11a are connected the corresponding scanning signal line (referred to as a “corresponding scanning signal line” for convenience of the description focusing on the pixel circuit) Sj, the scanning signal line Sj-1 immediately before the corresponding scanning signal line Sj (the last scanning signal line in the order of scanning of the scanning signal lines S1 to Sn, referred to as a “preceding scanning signal line” for convenience of the description focusing on the pixel circuit), the corresponding light emission control line (referred to as a “corresponding light emission control line” for convenience of the description focusing on the pixel circuit) Ej, the corresponding A data signal line (referred to as a “corresponding data signal line” for convenience of the description focusing on the pixel circuit) Dai, the high-level power source line ELVDD, the low-level power source line ELVSS, and the initialization line Vini. The B data signal line Dbi is connected to the B pixel circuit 11b as the corresponding data signal line in place of the A data signal line Dai. The other connections are the same as those of the A pixel circuit 11a. Note that, as described above, a data line capacitance Cdai is formed at the A data signal line Dai, and a data line capacitance Cdbi is formed at the B data signal line Dbi (see FIG. 2).

In the A pixel circuit 11a, the gate terminal of the writing transistor M2 is connected to the corresponding scanning signal line Sj, and the source terminal of the writing transistor M2 is connected to the corresponding data signal line Dai. In the B pixel circuit 11b, the gate terminal of the writing transistor M2 is connected to the corresponding scanning signal line Sj, and the source terminal of the writing transistor M2 is connected to the corresponding data signal line Dbi.

In each of the A pixel circuit 11a and the B pixel circuit 11b, the writing transistor M2 supplies the voltage of the corresponding data signal line Dxi, that is, the data voltage held in the data line capacitance Cdxi to the drive transistor M1 in a case that the corresponding scanning signal line Sj is selected (x=a, b).

The first conduction terminal of the drive transistor M1 is connected to the drain terminal of the writing transistor M2. The drive transistor M1 supplies a drive current I corresponding to the source-gate voltage Vgs to the organic EL element OLED.

The compensating transistor M3 is provided between the gate terminal and the second conduction terminal of the drive transistor M1. The gate terminal of the compensating transistor M3 is connected to the corresponding scanning signal line Sj. The compensating transistor M3 brings the drive transistor M1 to a diode-connected state in a case that the corresponding scanning signal line Sj is selected.

The first initialization transistor M4 includes a gate terminal connected to the preceding scanning signal line Sj-1, and is provided between the gate terminal of the drive transistor M1 and the initialization line Vini. The first initialization transistor M4 initializes the gate voltage Vg of the drive transistor M1 in a case that the preceding scanning signal line Sj-1 is selected. In addition, the second initialization transistor M7 includes a gate terminal connected to the preceding scanning signal line Sj-1, and is provided between an anode of the organic EL element OLED and the initialization line Vini. The second initialization transistor M7 initializes a voltage of a parasitic capacitance present between the gate terminal of the drive transistor M1 and the anode of the organic EL element OLED in a case that the preceding scanning signal line Sj-1 is selected. Thus, the non-uniformity of luminance due to the influence of the previous frame image is reduced.

The power-supplying transistor M5 includes a gate terminal connected to the light emission control line Ej and is provided between the high-level power source line ELVDD and the first conduction terminal of the drive transistor M1. The power-supplying transistor M5 supplies the high-level power supply voltage ELVDD to the source terminal as the first conduction terminal of the drive transistor M1 in a case that the light emission control line Ej is selected.

The light emission control transistor M6 includes a gate terminal connected to the light emission control line Ej, and is provided between the drain terminal as the second conduction terminal of the drive transistor M1 and the anode of the organic EL element OLED. The light emission control transistor M6 transmits the drive current I to the organic EL element OLED in a case that the light emission control line Ej is selected.

The data-holding capacitor C1 includes a first terminal connected to the high-level power source line ELVDD. The data-holding capacitor C1 is charged with the voltage of the corresponding data signal line Dxi (data voltage) when the corresponding scanning signal line Sj is in a select state, and holds the data voltage written by this charging when the corresponding scanning signal line Sj is in a non-select state, thereby maintaining the gate voltage Vg of the drive transistor M1.

The organic EL element OLED includes the anode connected to the second conduction terminal of the drive transistor M1 with the light emission control transistor M6 interposed therebetween and a cathode connected to the low-level power source line ELVSS. As a result, the organic EL element OLED emits light with a luminance in response to the drive current I.

### 1.3 Driving Method

### 1.3.1 Known Driving Method

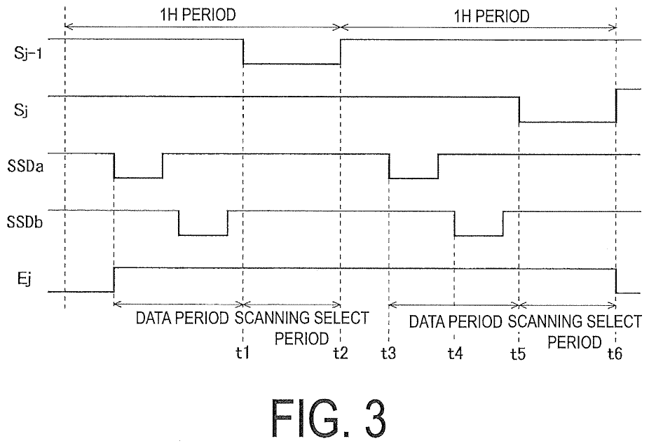

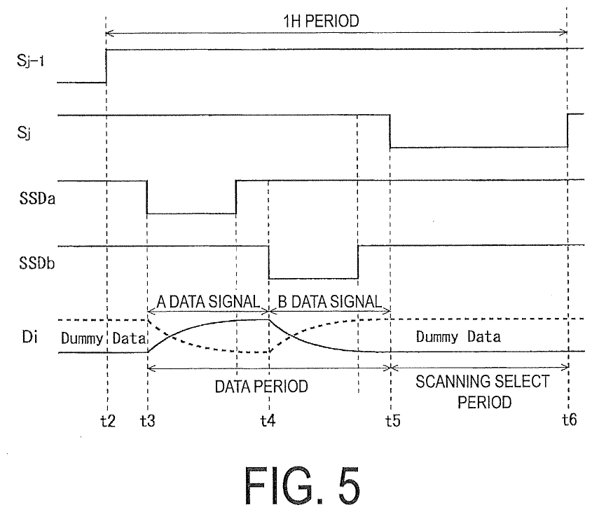

Before a description is made on a driving method of the display device 1 according to the present embodiment, a description is made on a drive of a display device in a case where a known driving method is adopted in the organic EL display device adopting the SSD method similar to that in the present embodiment, with reference to FIG. 2, FIG. 3, and FIG. 5. FIG. 3 is a signal waveform diagram illustrating a drive of the display device configured as illustrated in FIG. 1 and FIG. 2 in a case where the display device adopts the known driving method. That is, in FIG. 3, a focus is made on the two pixel circuits 11a and 11b, which are connected to the same scanning signal line Sj and are connected to the same demultiplexer 41 respectively via the two data signal lines Dai and Dbi, and waveforms of signals for driving these pixel circuits 11a and 11b are illustrated. FIG. 5 is a diagram of a detailed signal waveform together with a numerical value example during a 1 H period, for illustrating an operation of the display device in the case where the known driving method is adopted. Note that, the circuit element such as a transistor in the pixel circuits 11a and 11b described below are operated similarly in any of these pixel circuits 11a and 11b unless otherwise specified.

In the known driving method illustrated in FIG. 3, the voltage of the corresponding light emission control line Ej is changed from the low level to the high level before the preceding scanning signal line Sj-1 is changed to the low level during a horizontal interval (1 H period) including the scanning select period during which the voltage of the preceding scanning signal line Sj-1 is at the low level (active). Thus, in the pixel circuits 11a and 11b, the power-supplying transistor M5 and the light emission control transistor M6 are changed to the off state. With this, the organic EL element OLED is turns to a non-emitting state.

In addition, at the time t1, the voltage of the preceding scanning signal line Sj-1 is changed from the high level to the low level, and the preceding scanning signal line Sj-1 turns to a select state. Therefore, the first initialization transistor M4 turns to the on state. Thus, the gate voltage Vg of the drive transistor is initialized to the initialization voltage Vini. The initialization voltage Vini is such a voltage that the drive transistor M1 can be kept in an on state during the writing of the data voltage into the pixel circuit. More specifically, the initialization voltage Vini satisfies Relationship (5) given below.

Vini−Vdata<−Vth (5),

where Vdata is the data voltage, and Vth (>0) is the threshold voltage of the drive transistor M1. This initialization operation allows the data voltage to be reliably written into the pixel circuit. Note that, at the time t1, the voltage of the preceding scanning signal line Sj-1 is changed from the high level to the low level, whereby the second initialization transistor M7 also turns to the on state. As a result, the voltage of the parasitic capacitance present between the gate terminal of the drive transistor M1 and the anode of the organic EL element PLED is initialized. This initialization operation by the second initialization transistor M7 is not directly involved with the disclosure, and hence description thereof is omitted below (the same holds true in the other embodiments and the modified examples).

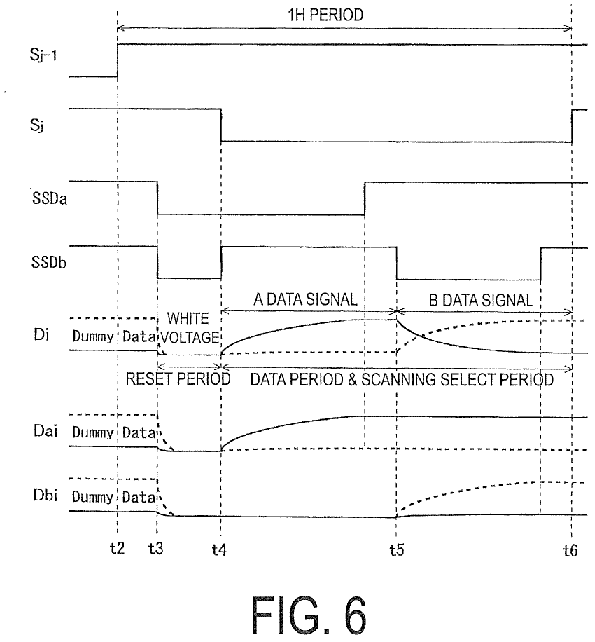

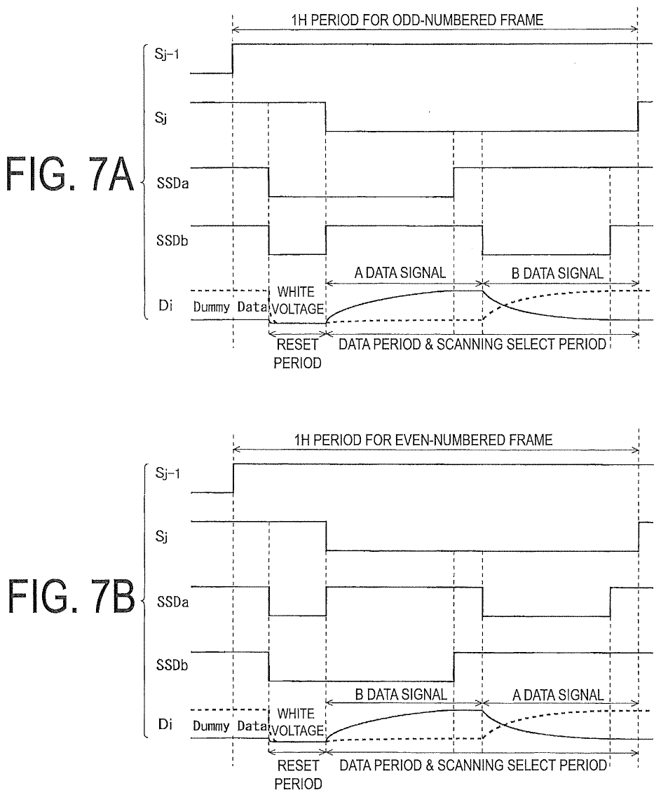

At the time t2, the voltage of the preceding scanning signal line Sj-1 is changed from the high level to the low level, thereby turning the preceding scanning signal line Sj-1 to the non-select state. Therefore, the first initialization transistor M4 turns to the off state. After that, at the period from the time t3 to the time t5, the A selection control signal SSDa and the B selection control signal SSDb sequentially turns to the low level for a predetermined period. With this, the A selecting transistor Ma and the B selecting transistor Mb in the demultiplexer 41 are sequentially turn to the on state for the predetermined period. Meanwhile, as illustrated in FIG. 5, during the period from the time t3 to the time t5, the A data signal and the B data signal are sequentially output from the output terminal Tdi of the data-side drive circuit 30 in conjunction with the A selection control signal SSDa and the B selection control signal SSDb (see the voltage waveform of the output line Di illustrated in FIG. 6) (hereinafter, the period during which the data signals are output from the output terminal Tdi of the data-side drive circuit 30 as described above is referred to as a “data period”). The voltages (data voltages) corresponding to the A data signal and the B data signal sequentially output are respectively supplied to the data signal lines Dai and Dbi through the demultiplexer 41, and are respectively held in the data line capacitances Cdai and Cdbi. Note that, at the time t4, the B selection control signal SSDb is changed from the high level to the low level. Before that, the A selection control signal SSDa is changed from the low level to the high level.

At the time t5 being a terminal point of the data period, both the selecting transistors Ma and Mb are in the off state. The voltage of the A data signal line Dai is maintained to the voltage of the A data signal by the data line capacitance Cdai, and the voltage of the B data signal line Dbi is maintained to the voltage of the B data signal by the data line capacitance Cdbi At the time t5, the voltage of the corresponding scanning signal line Sj is changed from the high level to the low level. Accordingly, the writing transistor M2 and the compensating transistor M3 turn to the on state. With this, the voltage held in the data line capacitance Cdai of the A data signal line Dai (corresponding to the voltage of the A data signal, and herein, being referred to as an “A data voltage VdA”) is supplied to the gate terminal of the drive transistor M1 via the writing transistor M2, the drive transistor M1, and the compensating transistor M3 in the A pixel circuit 11a. At this time, the drain terminal being the second conduction terminal of the drive transistor M1 and the gate terminal being the control terminal are electrically connected to each other. With this, the drive transistor M1 is in the diode-connected state. While the drive transistor M1 is in the diode-connected state, the gate voltage Vg of the drive transistor is changed toward the value obtained by Equation (1) given above (note that, Vdata=VdA is satisfied). Note that, in a strict sense, the electrical charge held in the data line capacitance Cdai is redistributed to the data line capacitance Cdai and the data-holding capacitor C1, and hence there is a possibility that the voltage that is actually supplied to the gate terminal of the drive transistor M1 is lower than the gate voltage Vg obtained by Equation (1) given above. However, each of the data line capacitances Cdxi (x=a, b) is sufficiently larger than the capacitance of the data-holding capacitor C1 in each of the pixel circuits 11x. Thus, in the following, decrease of the gate voltage Vg due to distribution of the above-mentioned electrical charge is negligible.

Further, at the time t5, when the voltage of the corresponding scanning signal line Sj is changed from the high level to the low level, the voltage held in the data line capacitance Cdbi of the B data signal line Dbi (corresponding to the voltage of the B data signal, and hereinafter, being referred to as a “B data voltage VdB”) is supplied to the gate terminal of the drive transistor M1 via the writing transistor M2, the drive transistor M1, and the compensating transistor M3 in the B pixel circuit 11b. Therefore, also in the B pixel circuit 11b, the circuit element such as a transistor inside the B pixel circuit 11b acts similarly to the circuit element in the A pixel circuit 11a, and the gate voltage Vg of the drive transistor is changed toward the value obtained by Equation (1) given above (note that, Vdata=VdB is satisfied).

The supply of the A data voltage VdA to the gate terminal of the drive transistor M1 in the A pixel circuit 11a and the supply of the B data voltage VdB to the gate terminal of the drive transistor M1 in the B pixel circuit 11b continue in the period during which the voltage of the corresponding scanning signal line Sj is at the low level, that is, during which the corresponding scanning signal line Sj is in the select state (the scanning select period from the time t5 to the time t6 illustrated in FIG. 3). As a result, during the scanning select period from the time t5 to the time t6, the data-holding capacitor C1 in each of the pixel circuits 11x is charged with the voltage of the corresponding data signal line Dxi (data voltage). With this, the voltage corresponding to the data voltage is written as gray scale data into (the data-holding capacitor C1 of) the pixel circuit 11 (x=a, b).

At the time t6, the voltage of the corresponding scanning signal line Sj is changed from the low level to the high level, and the scanning select period is terminated. Therefore, in each of the A pixel circuit 11a and the B pixel circuit 11b, the writing transistor M2 and the compensating transistor M3 are changed to the off state.

Further, at the time t6, the voltage of the corresponding light emission control line Ej is changed from the high level to the low level. Therefore, in each of the A pixel circuit 11a and the B pixel circuit 11b, the power-supplying transistor M5 and the light emission control transistor M6 change into the on state. Thus, the drive current I corresponding to the gate voltage Vg of the drive transistor M1 and the high-level power source line ELVDD, that is, the drive current I corresponding to the voltage held in the data-holding capacitor C1 is supplied to the organic EL element OLED, and the organic EL element OLED emits light in response to the current value of the drive current I. The drive current I is obtained by Equation (4) given above. The operation as described above is repeated n times during one frame period. With this, an image for one frame is displayed.

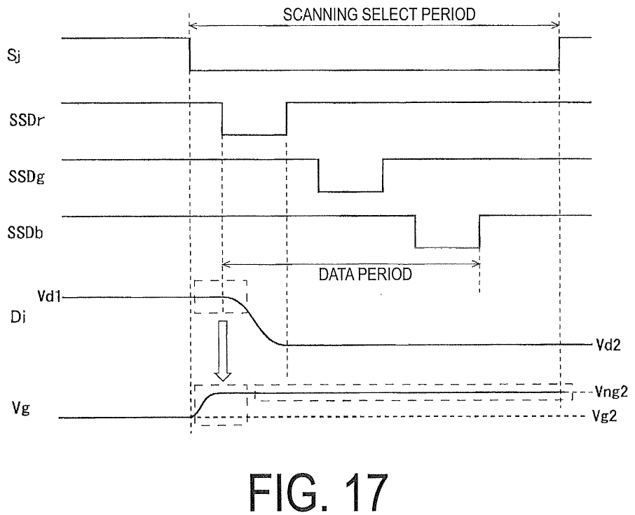

In the known driving method as illustrated in FIG. 3, the data period during which the data signal to be supplied to the data signal line Dxi via the demultiplexer 41 is output from the data-side drive circuit 30, and the scanning select period during which the voltages of the data signal lines Dai and Dbi are written into the data-holding capacitor C1 in each of the pixel circuits 11a and 11b, are separated from each other. Thus, as illustrated in FIG. 17, the problem described above, which is caused in the case where the data period and the scanning select period overlap with each other (the problem that the data voltage cannot be written accurately into the capacitor C1 in the pixel circuit) can be avoided. However, in the known driving method illustrated in FIG. 3, when a display image has a higher resolution, the data period (and the scanning select period) is reduced as the horizontal interval (the 1 H period) is shortened, which causes shortage of the charging of the data signal line for writing the gray scale data (and the data-holding capacitor in the pixel circuit). Therefore, a satisfactory display quality cannot be obtained as the display image has a higher resolution.

### 1.3.2 Driving Method in Present Embodiment

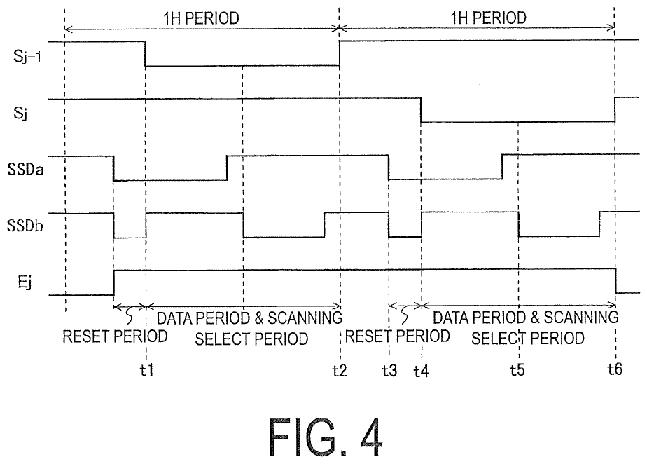

Next, with reference to FIG. 2, FIG. 4, and FIG. 6, description is made on the driving method of the display device 1 according to the present embodiment. FIG. 4 is a signal waveform diagram illustrating the drive of the display device 1 according to the present embodiment, which is illustrated in FIG. 1 and FIG. 2. Similarly to FIG. 3, in FIG. 4, a focus is made on the two pixel circuits 11a and 11b, which are connected to the same scanning signal line Sj and are connected to the same demultiplexer 41 respectively via the two data signal lines Dai and Dbi, and waveforms of signals for driving these pixel circuits 11a and 11b are illustrated. FIG. 6 is a diagram of detailed signal waveforms together with a numerical value example during a 1 H period, for illustrating the operation of the display device 1 according to the present embodiment. Note that, the circuit element such as a transistor in the pixel circuits 11a and 11b described below are operated similarly in any of these pixel circuits 11a and 11b unless otherwise specified.

In the driving method illustrated in FIG. 4, the voltage of the corresponding light emission control line Ej is changed from the low level to the high level before the preceding scanning signal line Sj-1 is changed to the low level during a horizontal interval (1 H period) including the scanning select period during which the voltage of the preceding scanning signal line Sj-1 is at the low level. Thus, in the pixel circuits 11a and 11b, the power-supplying transistor M5 and the light emission control transistor M6 are changed to the off state before the preceding scanning signal line Sj-1 is changed to the low level. With this, the organic EL element OLED is turns to a non-emitting state.

At the time t1, the voltage of the preceding scanning signal line Sj-1 is changed from the high level to the low level. Thus, the first initialization transistor M4 is changed to the on state. With this, the gate voltage Vg of the drive transistor M1 is initialized to the initialization voltage Vini. The initialization operation described above is similar to that in the known driving method described above, and hence detailed description thereof is omitted.

At the time t2, the voltage of the preceding scanning signal line Sj-1 is changed from the low level to the high level. In the present embodiment, a reset period (the period from the time t3 to the time t4 illustrated in FIG. 4) is provided before the data period and the scanning select period provided after the time t2. Specifically, at the time t3, both the A selection control signal SSDa and the B selection control signal SSDb are changed from the high level to the low level, and remain at the low level until the time t4. During the reset period, as illustrated in FIG. 6, the display control circuit 20 controls the data-side drive circuit 30 such that the data-side drive circuit 30 outputs a white voltage from each of the output terminals Tdi (i=1 to m) to the output line Di. Here, the white voltage is a voltage corresponding to white display (maximum luminance gray scale), and corresponds to the minimum voltage that the data voltage may have during the scanning select period in the present embodiment. Note that, the reset voltage to be output from each of the output terminals Tdi of the data-side drive circuit 30 during the reset period (hereinafter, referred to as a “reset voltage”) is not limited to the white voltage. Specifically, the reset voltage is only required to be a voltage that initializes each of the data signal lines Dxi in order to be capable of charging the data-holding capacitor C1 via the drive transistor M1 in the diode-connected state in the pixel circuit 11x regardless of the voltage that the data voltage may have during the scanning select period (x=a, b).

As apparent from FIG. 2, in the present embodiment, during the reset period from the time t3 to the time t4, the white voltages are supplied to the data signal lines Dai and Dbi via the demultiplexer 41, and are respectively held in the data line capacitances Cdai and Cdbi.

At the time t4 being a terminal point of the reset period, the B selection control signal SSDb is changed from the low level to the high level (inactive), and the voltage of the corresponding scanning signal line Sj is changed from the high level to the low level. With this, the corresponding scanning signal line Sj turns to the select state. The A selection control signal SSDa is maintained at the low level after the time t3, and after that, the A selection control signal SSDa is changed from the low level to the high level before the B selection control signal SSDb is changed to the low level at the time t5. Note that, in the example illustrated in FIG. 4, the reset period (from the time t3 to the time t4) and the data period (from the time t4 to the time t5) for the A data signal are continuous (see FIG. 6). However, those periods may be separated from each other.

The period from the time t4 to the time t6 corresponds to the date period. During the data period, the A selection control signal SSDa and the B selection control signal SSDb are sequentially changed to the low level for the predetermined period. With this, the A selecting transistor Ma and the B selecting transistor Mb in the demultiplexer 41 sequentially turn to the on state for the predetermined period. Meanwhile, as illustrated in FIG. 6, during the data period, the A data signal and the B data signal are sequentially output from the output terminal Tdi of the data-side drive circuit 30 to the output line Di in conjunction with the A selection control signal SSDa and the B selection control signal SSDb. The voltages of the A data signal and the B data signal that are sequentially output are respectively supplied to the data signal lines Dai and Dbi by the above-mentioned demultiplexer 41, and are respectively held in the data line capacitances Cdai and Cdbi. Further, the corresponding scanning signal line Sj is changed to the low level at the time t4, and after that, changed to the high level at the time t5. Thus, the period from the time t4 to the time t6 also corresponds to the scanning select period (hereinafter, the period corresponding to both the data period and the scanning select period as described above is described as “the data period & the scanning select period”), and the writing transistor M2 and the compensating transistor M3 are in the on state during the scanning select period. Note that, as illustrated in FIG. 6, the A selecting transistor Ma and the B selecting transistor Mb are alternatingly in the on state for the predetermined period after the terminal point of the reset period at the time t4 in the 1 H period. The predetermined period (the period during which the selection control signal SSDx is at the low level after the terminal point t4) is the period during which each of the data line capacitances Cdxi (x=a, b) are charged with the voltages of the data signals. It is preferred that the period be prolonged within such a range that demultiplex of the data signals by the demultiplexer 41 and charging (pixel charging) of the data-holding capacitor C1 in the pixel circuit 11x can be performed appropriately during the period from the time t4 to the time t6. Further, in the present embodiment, the length of the predetermined period is identical for the A selecting transistor Ma and the B selecting transistor Mb. However, in consideration of, for example, a charging time or a capacitance value of the data-holding capacitor C1 in each of the pixel circuits 11x (x=a, b), the length of the predetermined period may differ between the A selecting transistor Ma and the B selecting transistor Mb.

Based on the description given above, after the time t4 in the data period & the scanning select period from the time t4 to the time t6, the voltage of the A data signal is supplied to the A data signal line Dai, is held as the A data voltage VdA in the data line capacitance Cdai, and is supplied to the data-holding capacitor C1 in the A pixel circuit 11a via the drive transistor M1 in the diode-connected state. With this, the gate voltage Vg of the drive transistor M1 is also changed toward the value obtained by Equation (1) given above (note that, Vdata=VdA is satisfied). Further, after the time t5 in the data period & the scanning select period, the voltage of the B data signal is supplied to the B data signal line Dbi, is held as the B data voltage VdB in the data line capacitance Cdbi, and is supplied to the data-holding capacitor C1 in the B pixel circuit 11b via the drive transistor M1 in the diode-connected state. With this, the gate voltage Vg of the drive transistor M1 is also changed toward the value obtained by Equation (1) given above (note that, Vdata=VdB is satisfied).

At the time t6, the voltage of the corresponding scanning signal line Sj is changed from the low level to the high level, and the scanning select period is terminated. Therefore, in each of the A pixel circuit 11a and the B pixel circuit 11b, the writing transistor M2 and the compensating transistor M3 are changed to the off state.

Further, at the time t6, the voltage of the corresponding light emission control line Ej is changed from the high level to the low level. Therefore, in each of the A pixel circuit 11a and the B pixel circuit 11b, the power-supplying transistor MS and the light emission control transistor M6 change into the on state. Thus, the drive current I corresponding to the gate voltage Vg of the drive transistor M1 and the high-level power source line ELVDD, that is, the drive current I corresponding to the voltage held in the data-holding capacitor C1 is supplied to the organic EL element OLED, and the organic EL element OLED emits light in response to the current value of the drive current I. The drive current I is obtained by Equation (4) given above. The operation as described above is repeated n times during one frame period. With this, an image for one frame is displayed.

### 1.4 Effects

Now, with reference to FIG. 5 and FIG. 6, a description is provided on effects of the present embodiment described above. FIG. 5 illustrates waveforms of main signals for driving the pixel circuits 11a and 11b illustrated in FIG. 2 during the 1 H period in the case where the known driving method described above is adopted, and FIG. 6 illustrates waveform of main signals for driving the pixel circuits 11a and 11b illustrated in FIG. 2 during the 1 H period in the present embodiment.

For the purpose of description, a case where a display image has a resolution including the pixel number of 1080×1920 and the 1 H period (the 1 horizontal interval) is 8.18 μs is assumed. The time period in the 1 H period during which the voltage of the data signal (the data voltage) is written into each of the data signal lines Dxi (x=a, b), that is, the time period during which each of the data line capacitances Cdxi is charged with the data voltage (hereinafter, referred to as a “data line charging period”) corresponds to the period during which the selecting transistor Mx is in the on state in the demultiplexer 41 to which the data signal line Dxi is connected. In a case where the known driving method described above is adopted under the above described condition that the 1 H period is 8.18 μs, for example, in a waveform illustrated in FIG. 5, when the time period from a starting point of the 1 H period to the time at which any of the selecting transistors Mx turns to the on state (the time period until any of the selection control signals SSDx is changed to the low level) is set to 1.5 μs, the scanning select period is set to 3.0 μs, the interval between the on periods of the selecting transistors Mx (the interval between the periods during which the selection control signal SSDx are at the low level) is set to 0.4 μs, and the interval between the last on period of the select transistor Mx and the scanning select period is set to 0.4 μs (x=a, b), the data line charging period is 1.44 μs. With regard to this, in the present embodiment, in a waveform illustrated in FIG. 6, when the reset period is set to 1.0 μs under the same condition, the data period overlaps with the scanning select period. Thus, the data line charging period is 2.44 μs, which is increased to a larger extent as compared to the known driving method described above.

Further, in the present embodiment, as illustrated in FIG. 6, in the reset period provided before the data period including the data line charging period (the data period & the scanning select period), the white voltage is suppled as the reset voltage to each of the data signal lines Dxi. Thus, even when the data period and the scanning select period overlap with each other, the data writing failure caused by the diode-connection as illustrated in FIG. 17 does not occur.

As described above, according to the present embodiment, while avoiding the data writing failure caused by the diode-connection, the data period and the scanning select period overlap with each other. In this manner, without reducing the scanning select period, the data line charging period can be increased to a larger extent compared to the related art. With this, in the organic EL display device adopting the SSD method, sufficient charging of the data voltage and sufficient internal compensation in the pixel circuit can be performed even in a case that a display image has a higher resolution.

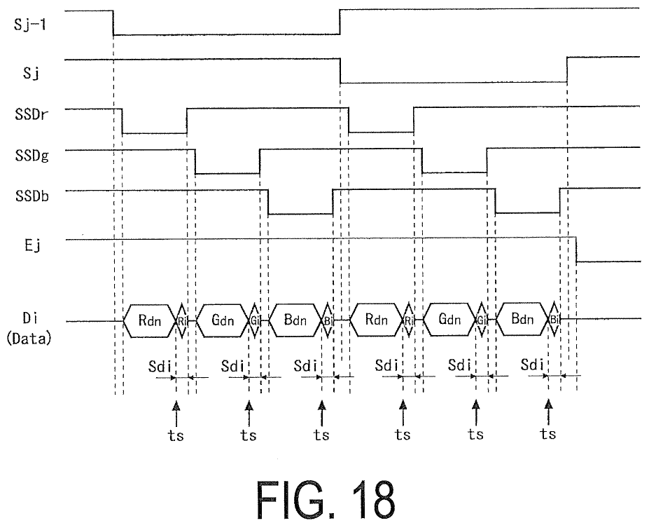

Note that, also in the second known example illustrated in FIG. 18, by providing the data line initialization stage Sdi in place of the reset period in the present embodiment, the data period and the scanning select period can overlap with each other while avoiding the data writing failure caused by the diode-connection. However, the three data line initialization stages Sdi are included while the scanning lines are in the select state (each of the scanning select periods) during each of the horizontal intervals (the 1 H periods). With respect to this point, in the present embodiment, only one reset period is included in each of the horizontal intervals (1 H periods) (see FIG. 4 and FIG. 6). Therefore, the present embodiment is more advantageous than the second known example in the point that sufficient charging of the data voltage in the pixel circuit and sufficient internal compensation can be performed even when a display image has a higher resolution.

### 1.5 Modified Example in First Embodiment

In the first embodiment described above, as apparent from FIG. 6, the data line charging period by the A data signal, that is, the period during which the A selecting transistor Ma is in the on state and the A data signal is supplied to the A data signal line Dai (hereinafter, referred to as an “A data line charging period”) precedes the data line charging period by the B data signal, that is, the period during which the B selecting transistor Mb is in the on state and the B data signal is supplied to the B data signal line Dbi (hereinafter, referred to as a “B data line charging period”), and the scanning select period matches with the data period. Thus, in the data period & the scanning select period, the time period during which the data-holding capacitor C1 in the A pixel circuit 11a is charged with the data voltage held in (the data line capacitance Cdai of) the A data signal line Dai is longer than the time period during which the data-holding capacitor C1 in the B pixel circuit 11b is charged with the data voltage held in (the data line capacitance Cdbi of) the B data signal line Dbi. As a result, a difference in charging rate of the data-holding capacitor C1 is generated between the A pixel circuit 11a and the B pixel circuit 11b, which may cause a difference in luminance.

In view of this, a configuration in which a temporal before/after relationship between the A data line charging period and the B data line charging period in each of the horizontal intervals is switched for one or more predetermined frame periods is conceivable. Each of FIGS. 7A and 7B is a waveform diagram illustrating an operation of a display device according to a modified example of the first embodiment having the configuration described above, and illustrates waveforms of main signals for driving the pixel circuits 11a and 11b illustrated in FIG. 2 during the 1 H period. Here, a description of the present modified example will be provided. Note that, among the configurations of the present modified example, parts similar to those in the first embodiment described above are denoted with the same reference symbols, and description thereof is omitted.

In the present modified example, the display control circuit 20 controls the demultiplexer unit 40 and the data-side drive circuit 30 such that, similarly to the first embodiment described above, the A data line charging period precedes the B data line charging period during each of the horizontal intervals (the 1 H periods) in the odd-numbered frames (see FIG. 7A) and that the B data line charging period precedes the A data line charging period during each of the horizontal intervals (the 1 H periods) in the even-numbered frames (see FIG. 7B). Specifically, the display control circuit 20 in the present modified example is configured to generate the data signals of the A selection control signal SSDa, the B selection control signal SSDb, and the output line Di of the data-side drive circuit 30, which are illustrated in FIG. 7A or FIG. 7B, in accordance with the odd-numbered frames and the even-numbered frames. Note that, the data signal of the output line Di is generated by the data-side drive circuit 30 based on the display data DA and the like supplied from the display control circuit 20 to the data-side drive circuit 30.

According to the present modified example described above, the temporal before/after relationship between the A data line charging period and the B data line charging period during each of the horizontal intervals is switched for one frame period, and hence even when a difference in charging rate of the data-holding capacitor C1 between the A pixel circuit 11a and the B pixel circuit 11b causes a difference in luminance, the luminance difference is balanced in a temporal manner, which is less visually recognizable to an observer. Therefore, the present modified example can exert effects similar to those in the first embodiment described above, and can suppress the luminance difference in a visual manner and improve display quality as compared to the first embodiment described above.

### 2. Second Embodiment

### 2.1 Overall Configuration

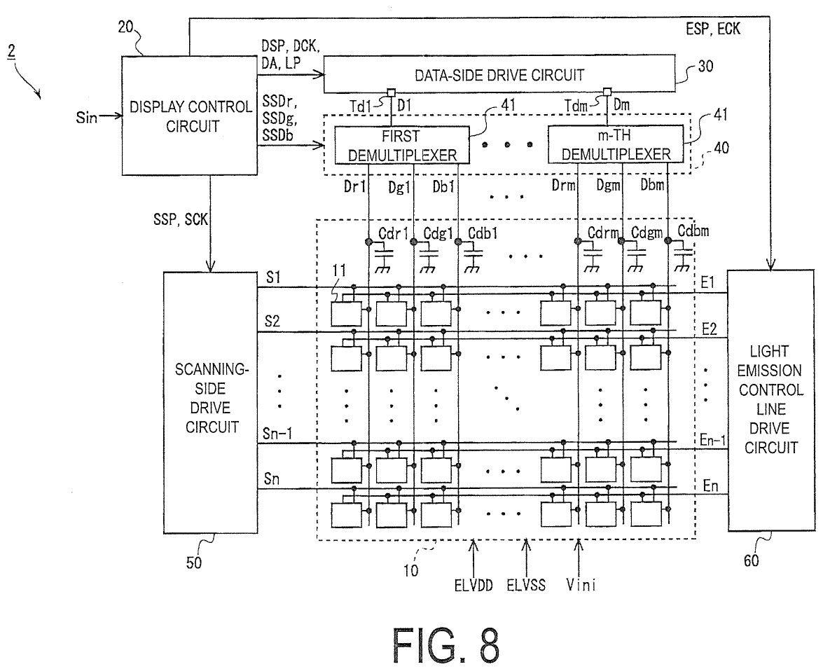

FIG. 8 is a block diagram illustrating an overall configuration of a display device 2 according to a second embodiment. The display device 2 is an organic EL display device adopting the SSD method for performing internal compensation, and performs color display with three primary colors including red, green, and blue. As illustrated in FIG. 8, similarly to the first embodiment described above, the display device 2 also includes the display unit 10, the display control circuit 20, the data-side drive circuit 30, the demultiplexer unit 40, the scanning-side drive circuit 50, and the light emission control line drive circuit 60.

The display unit 10 includes m×k (m and k are integers equal to or more than 2) data signal lines disposed therein. In the present embodiment, k=3 is satisfied, which is different from the first embodiment described above where k=2 is satisfied. That is, in the disclosure, in the display unit 10, 3m data signal lines Dr1, Dg1, Db1, Dr2, Dg2, Db2, . . . , Drm, Dgm, and Dbm and n scanning signal lines S1 to Sn intersecting these data signal lines are disposed, and n light emission control lines E1 to En are respectively disposed along the n scanning signal lines S1 to Sn. Further, as illustrated in FIG. 8, the display unit 10 is provided with the 3m×n pixel circuits 11, and those 3m×n pixel circuits 11 are arranged in a matrix shape along the 3m data signal lines Dx1 to Dxm (x=r, g, b) and the n scanning signal lines S1 to Sn in such a manner that each of these 3m x n pixel circuits 11 corresponds to any one of the 3m data signal lines Dx1 to Dxm (x=r, g, b) and also corresponds to any one of the n scanning signal lines S1 to Sn and any one of the n light emission control lines E1 to En. The 3m data signal lines Dx1 to Dxm (x=r, g, b) are connected to the demultiplexer unit 40, the n scanning signal lines S1 to Sn are connected to the scanning-side drive circuit 50, and the n light emission control lines E1 to En are connected to the light emission control line drive circuit 60.

Further, similarly to the first embodiment, in the display unit 10, the high-level power source line ELVDD and the low-level power source line ELVSS are disposed as power source lines (not illustrated) common in each pixel circuit 11, and the initialization line Vini for supplying the initialization voltage Vini is disposed. These voltages are supplied from a power source circuit (not illustrated).

In FIG. 8, each of the wiring line capacitances Cdr1 to Cdrm formed in the m data signal lines Dr1 to Drm (hereinafter, also referred to as “R data signal lines Dr1 to Drm”) is illustrated as a capacitor, each of the wiring line capacitances Cdg1 to Cdgm formed in the m data signal lines Dg1 to Dgm (hereinafter, also referred to as “G data signal lines Dg1 to Dgm”) is illustrated as a capacitor, and each of the wiring line capacitances Cdb1 to Cdbm formed in the m data signal lines Db1 to Dbm (hereinafter, also referred to as “B data signal lines Db1 to Dbm”) is illustrated as a capacitor (hereinafter, those wiring capacitances Cdxi (x=r, g, b; i=1 to m) are referred to as “data line capacitances”). A ground voltage is applied to one end (on a side not connected to the data signal line Dxi) of each data line capacitance Cdxi, but the disclosure is not limited thereto.

The display control circuit 20 receives an input signal Sin including image information representing an image to be displayed and timing control information for image display from the outside of the display device 2, and on the basis of the input signal Sin, outputs various control signals to the data-side drive circuit 30, the demultiplexer unit 40, the scanning-side drive circuit 50, and the light emission control line drive circuit 60. More specifically, the display control circuit 20 outputs a data start pulse DSP, a data clock signal DCK, display data DA, and a latch pulse LP to the data-side drive circuit 30. The display data DA contains R data, G data, and B data. Further, the display control circuit 20 also outputs a R selection control signal SSDr, a G selection control signal SSDg, a B selection control signal SSDb to the demultiplexer unit 40, which is different from the first embodiment described above. Furthermore, the display control circuit 20 outputs a scan start pulse SSP and a scan clock signal SCK to the scanning-side drive circuit 50. Furthermore, the display control circuit 20 outputs a light emission control start pulse ESP and a light emission control clock signal ECK to the light emission control line drive circuit 60.

Similarly to the first embodiment, the data-side drive circuit 30 includes an m-bit shift register, a sampling circuit, a latch circuit, m D/A converters, and the like, which are not illustrated. The m D/A converters correspond to the m output lines D1 to Dm respectively connected to m output terminals Td1 to Tdm of the data-side drive circuit 30, and supply the analog data signals based on the display data DA to the output lines D1 to Dm. The display device 2 according to the present embodiment performs the color display of RGB three-primary colors (the three-primary colors including red, green, and blue) and adopts the SSD method, and hence the R data signal, the G data signal, the B data signal are supplied to each of the output lines Di sequentially (in a time-division manner). Here, the R data signal is a data signal to be applied to the R data signal lines Dr1 to Drm among the 3m data signal lines Dx1 to Dxm (x=r, g, b) in the display unit 10 and indicates a red-color component of an image to be displayed. The G data signal is a data signal to be applied to the G data signal lines Dg1 to Dgm among the 3m data signal lines Dx1 to Dxm and indicates a green-color component of an image to be displayed. The B data signal is a data signal to be applied to the B data signal lines Db1 to Dbm among the 3m data signal lines Dx1 to Dxm and indicates a blue-color component of an image to be displayed.

The demultiplexer unit 40 includes m demultiplexers 41 which are first to m-th demultiplexers 41 respectively corresponding to the m output terminals Td1 to Tdm of the data-side drive circuit 30. The input terminal of the i-th demultiplexer is connected to the corresponding output terminal Tdi of the data-side drive circuit 30 with the output line Di interposed therebetween (i=1 to m). Each of the demultiplexers 41 includes three output terminals, and the three output terminals of the i-th demultiplexer 41 are respectively connected to three data signal lines Dri, Dgi, and Dbi, which is different from the first embodiment described above. The i-th demultiplexer 41 supplies the R data signal, the G data signal, and the B data signal sequentially supplied from the output terminal Tdi of the data-side drive circuit 30 via the output line Di respectively to the R data signal line Dri, the G data signal line Dgi, and the B data signal line Dbi. The operation of each demultiplexer 41 is controlled by the R selection control signal SSDr, the G selection control signal SSDg, and the B selection control signal SSDb. With the SSD method, the number of output lines connected to the data-side drive circuit 30 can be reduced to one-third as compared to the case where the SSD method is not adopted. Thus, the circuit scale of the data-side drive circuit 30 is reduced, and hence the manufacturing cost of the data-side drive circuit 30 can be reduced.

The scanning-side drive circuit 50 drives the n scanning signal lines S1 to Sn similarly to the first embodiment. More specifically, the scanning-side drive circuit 50 includes a shift register, buffers, and the like (not illustrated). The shift register sequentially transfers the scan start pulse SSP in synchronization with the scan clock signal SCK. The scanning signal being the output from each stage of the shift register is supplied to the corresponding scanning signal line Sj (j=1 to n) via a buffer. The 3m pixel circuits 11 connected to the scanning signal line Sj are collectively selected by the active scanning signals (at the low level scanning signals in the present embodiment).

The light emission control line drive circuit 60 drives n light emission control lines E1 to En similarly to the first embodiment described above. More specifically, the light emission control line drive circuit 60 includes a shift register, buffers, and the like (not illustrated). The shift register sequentially transfers the light emission control start pulse ESP in synchronization with the light emission control clock signal ECK. The light emission control signal being the output from each stage of the shift register is supplied to the corresponding light emission control line Ej (j=1 to n) via a buffer.

As illustrated in FIG. 8, similarly to the first embodiment described above, the scanning-side drive circuit 50 is separated from the light emission control line drive circuit 60, is arranged on one end side of the display unit 10 (the left side of the display unit 10 in FIG. 8), and the light emission control line drive circuit 60 is arranged on the other end of the display unit 10 (the right side of the display unit 10 in FIG. 8). However, the scanning-side drive circuit 50 is not limited to the above-mentioned arrangement and configuration.

2.2 Connection Relation between Pixel Circuit and Various Wiring Lines

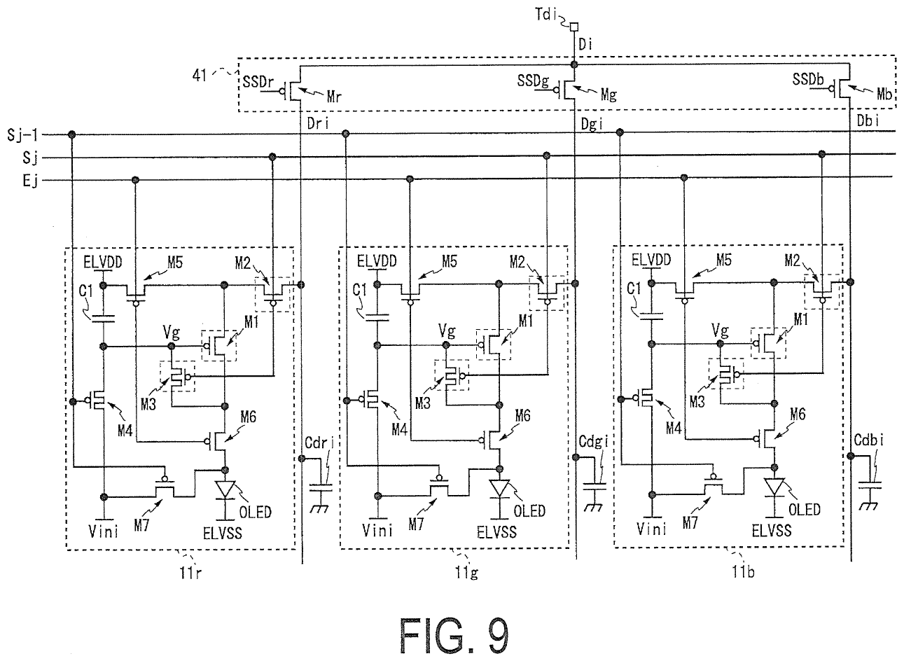

FIG. 9 is a circuit diagram illustrating a connection relationship between a part of pixel circuits 11r, 11g, and 11b and various wiring lines in the present embodiment. Among the 3m×n pixel circuits 11 in the display unit 10, these pixel circuits 11r, 11g, and 11b are connected to the same scanning signal line Sj, and are connected to the same demultiplexer 41 via the respective three data signal lines Dri, Dgi, and Dbi. Here, the reference symbol “11r” is used to indicate the pixel circuit 11 connected to the R data signal line Dri (hereinafter, also referred to as a “R pixel circuit”), the reference symbol “11g” is used to indicate the pixel circuit 11 connected to the G data signal line Dgi (hereinafter, also referred to as a “G pixel circuit”), and the reference symbol “11b” is used to indicate the pixel circuit 11 connected to the B data signal line Dbi (hereinafter, also referred to as a “B pixel circuit”).

As illustrated in FIG. 9, each of the demultiplexers 41 includes a R selecting transistor Mr, a G selecting transistor Mg, and a B selecting transistor Mb, and all of these selecting transistors Mr, Mg, and Mb function as switching elements. A R selection control signal SSDr is supplied to the gate terminal as a control terminal of the R selecting transistor Mr, a G selection control signal SSDg is supplied to the gate terminal as a control terminal of the G selecting transistor Mg, and a B selection control signal SSDb is supplied to the gate terminal as a control terminal of the B selecting transistor Mb. The drain terminals as first conduction terminals of these selecting transistors Mr, Mg, and Mb are respectively connected to the data signal lines Dri, Dgi, and Dbi, and all of the source terminals as second conduction terminals of these selecting transistors Mr, Mg, and Mb are connected to the output line Di (i=1 to m). Therefore, each output line Di is connected to the R data signal line Dri with the R selecting transistor Mr interposed therebetween, to the G data signal line Dgi with the G selecting transistor Mg interposed therebetween, and to the B data signal line Dbi with the B selecting transistor Mb interposed therebetween in the corresponding demultiplexer 41.

Next, a description of the configuration of the pixel circuit is provided. As illustrated in FIG. 9, the R pixel circuit 11r, the G pixel circuit 11g, and the B pixel circuit 11b are sequentially arrayed in the extending direction of the scanning signal line. Note that, the configurations of the R pixel circuit 11r, the G pixel circuit 11g, and the B pixel circuit 11b are basically the same. Thus, in the following, the parts common to one another in these pixel circuits are described by taking the configuration of the R pixel circuit 11r as an example, and the parts different from one another in these pixel circuits are described individually as appropriate.

To be more specific, similarly to the A pixel circuit 11a and the B pixel circuit 11b in the first embodiment described above, the R pixel circuit 11r includes the organic EL element OLED, the drive transistor M1, the writing transistor M2, the compensating transistor M3, the first initialization transistor M4, the power-supplying transistor M5, the light emission control transistor M6, the second initialization transistor M7, the data-holding capacitor C1 being a holding capacitance configured to hold the data voltage, and the connection relationships between these elements are the same (see FIG. 2 and FIG. 9). Note that, the G pixel circuit 11g and the B pixel circuit 11b also include elements similar to those of the R pixel circuit 11r, and the connection relationships between the elements included in the elements of the G pixel circuit 11g and the B pixel circuit 11b are also the same as those of the R pixel circuit 11r (see FIG. 9).

To the R pixel circuit 11r, the scanning signal line Sj corresponding thereto (the corresponding scanning signal line), the scanning signal line Sj-1 preceding the corresponding scanning signal line Sj (the preceding scanning signal line), the light emission control line Ej corresponding thereto (corresponding light emission control line), the R data signal line Dri corresponding thereto (corresponding data signal line), the high-level power source line ELVDD, the low-level power source line ELVSS, and the initialization power source line Vini are connected. The G data signal line Dgi is connected to the G pixel circuit 11g as the corresponding data signal line in place of the R data signal line Dri. The other connections are the same as those of the R pixel circuit 11r. The B data signal line Dbi is connected to the B pixel circuit 11b as the corresponding data signal line in place of the R data signal line Dri. The other connections are the same as those of the R pixel circuit 11r. Note that, as described above, a data line capacitance Cdri is formed at the R data signal line Dri, a data line capacitance Cdgi is formed at the G data signal line Dgi, and a data line capacitance Cdbi is formed at the B data signal line Dbi (see FIG. 8).

In the R pixel circuit 11r, the gate terminal of the writing transistor M2 is connected to the corresponding scanning signal line Sj, and the source terminal of the writing transistor M2 is connected to the corresponding data signal line Dri. In the G pixel circuit 11g, the gate terminal of the writing transistor M2 is connected to the corresponding scanning signal line Sj, and the source terminal of the writing transistor M2 is connected to the corresponding data signal line Dgi. In the B pixel circuit 11b, the gate terminal of the writing transistor M2 is connected to the corresponding scanning signal line Sj, and the source terminal of the writing transistor M2 is connected to the corresponding data signal line Dbi.

In each of the R pixel circuit 11r, the G pixel circuit 11g, and the B pixel circuit 11b, the writing transistor M2 supplies the voltage of the corresponding data signal line Dxi, that is, the data voltage held in the data line capacitance Cdxi to the drive transistor M1 in a case that the corresponding scanning signal line Sj is selected (x=r, g, b).

The configurations (wiring and connection relationships) other than those described above in each of the R pixel circuit 11r, the G pixel circuit 11g, and the B pixel circuit 11b are similar to the configurations of the A pixel circuit 11a and the B pixel circuit 11b in the first embodiment described above. Thus, description thereof is omitted (see FIG. 2 and FIG. 9).

### 2.3 Driving Method

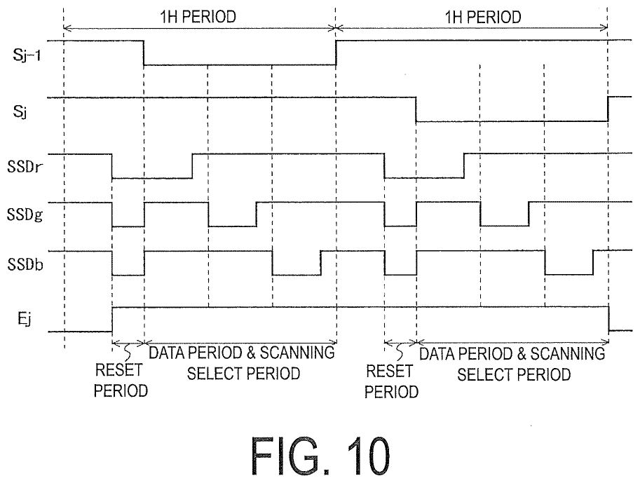

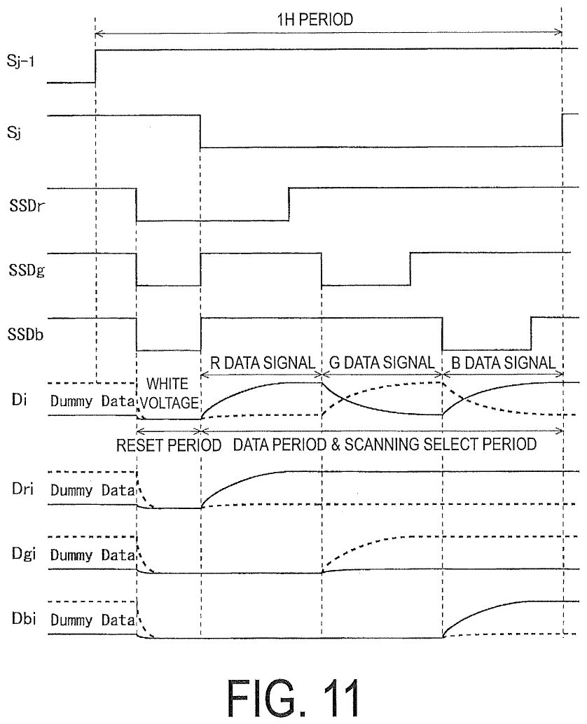

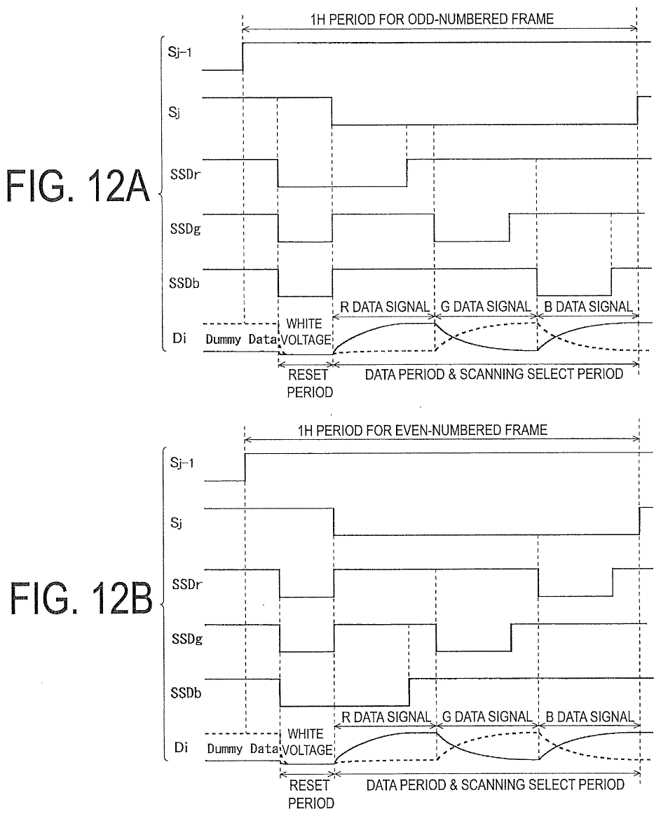

Next, with reference to FIG. 9, FIG. 10, and FIG. 11, a description of a driving method of the display device 2 according to the present embodiment will be provided. FIG. 10 is a signal waveform diagram illustrating a drive of the display device 2 according to the present embodiment, which is illustrated in FIG. 8 and FIG. 9. In FIG. 10, a focus is made on the three pixel circuits 11r, 11g, and 11b, which are connected to the same scanning signal line Sj and are connected to the same demultiplexer 41 respectively via the three data signal lines Dri, Dgi, and Dbi, and waveforms of signals for driving these pixel circuits 11r, 11g, and 11b are illustrated. FIG. 11 is a diagram of detailed signal waveforms together with a numerical value example during the 1 H period, for illustrating the operation of the display device 2 according to the present embodiment. Note that, the circuit element such as a transistor in the pixel circuits 11r, 11g, and 11b described below are operated similarly in any of these pixel circuits 11r, 11g, and 11b unless otherwise specified.

As illustrated in FIG. 10 and FIG. 11, similarly to the first embodiment described above (FIG. 4 and FIG. 6), the reset period is provided before the data period & the scanning select period. In the present embodiment, during the reset period, the R selection control signal SSDr, the G selection control signal SSDg, and the B selection control signal SSDb are all at the low level, and hence the R selecting transistor Mr, the G selecting transistor Mg, and the B selecting transistor Mb are all in the on state. Similarly to the first embodiment described above, as illustrated in FIG. 11, the display control circuit 20 controls the data-side drive circuit 30 such that the data-side drive circuit 30 outputs the white voltage as the reset voltage from each of the output terminals Tdi (i=1 to m) to the output line Di during the reset period. As apparent from FIG. 9, in the present embodiment, during the reset period, the white voltages are supplied to the data signal lines Dri, Dgi, and Dbi via the demultiplexer 41, and are respectively held in the data line capacitances Cdri, Cdgi, and Cdbi.

At the terminal point of the reset period, the G selection control signal SSDg and the B selection control signal SSDb are changed from the low level to the high level (inactive), and the voltage of the corresponding scanning signal line Sj is changed from the high level to the low level (active). Even after the reset period, the R selection control signal SSDr maintains at the low level only for the predetermined period, and then is changed from the low level to the high level before the G selection control signal SSDg is changed to the low level (note that, in the example illustrated in FIG. 10 and FIG. 11, the reset period and the data period for the R data signal line Dri are continuous, but these periods may be separated from each other). After that, the G selection control signal SSDg maintains at the low level only for the predetermined period, and then is changed from the low level to the high level before the B selection control signal SSDb is changed to the low level. After that, the B selection control signal SSDb maintains at the low level only for the predetermined period, and then is changed from the low level to the high level before the voltage of the corresponding scanning signal line Sj is changed from the low level to the high level (inactive).

In the present embodiment as described above, as illustrated in FIG. 10 and FIG. 11, during the data period & the scanning select period, the R selection control signal SSDr, the G selection control signal SSDg, and the B selection control signal SSDb are sequentially changed to the low level for the predetermined period. With this, the R selecting transistor Mr, the G selecting transistor Mg, and the B selecting transistor Mb in the demultiplexer 41 sequentially turn to the on state for the predetermined period. Meanwhile, as illustrated in FIG. 11, during the data period & the scanning select period, the R data signal, the G data signal, and the B data signal are sequentially output from the output terminal Tdi of the data-side drive circuit 30 in conjunction with the R selection control signal SSDr, the G selection control signal SSDg, and the B selection control signal SSDb (see the voltage waveform of the output line Di illustrated in FIG. 11). The voltages (data voltages) of the R data signal, the G data signal, and the B data signal that are sequentially output are respectively supplied to the data signal lines Dri, Dgi, and Dbi by the above-mentioned demultiplexer 41, and are respectively held in the data line capacitances Cdri, Cdgi, and Cdbi.

As described above, after the time point in the data period & the scanning select period at which the voltage of the corresponding scanning signal line Sj is changed to the low level (active), the voltage of the R data signal is supplied to the R data signal line Dri, is held as the R data voltage VdR by the data line capacitance Cdri, and is supplied to the data-holding capacitor C1 in the R pixel circuit 11r via the drive transistor M1 in the diode-connected state. With this, the gate voltage Vg of the drive transistor M1 is also changed toward the value obtained by Equation (1) given above (note that, Vdata=VdR is satisfied). Further, after the time period in the data period & the scanning select period at which the G selection control signal SSDg is changed to the low level (active), the voltage of the G data signal is supplied to the G data signal line Dgi, is held as the G data voltage VdG in the data line capacitance Cdgi, and is supplied to the data-holding capacitor C1 in the G pixel circuit 11g via the drive transistor M1 in the diode-connected state. With this, the gate voltage Vg of the drive transistor M1 is also changed toward the value obtained by Equation (1) given above (note that, Vdata=VdG is satisfied). Further, after the time point in the data period & the scanning select period at which the B selection control signal SSDb is changed to the low level (active), the voltage of the B data signal is supplied to the B data signal line Dbi, is held as the B data voltage VdB in the data line capacitance Cdbi, and is supplied to the data-holding capacitor C1 in the B pixel circuit 11b via the drive transistor M1 in the diode-connected state. With this, the gate voltage Vg of the drive transistor M1 is also changed toward the value obtained by Equation (1) given above (note that, Vdata=VdB is satisfied).

At the terminal point of the data period & the scanning select period, the voltage of the corresponding scanning signal line Sj is changed from the high level to the low level. Therefore, in each of the R pixel circuit 11r, the G pixel circuit 11g, and the B pixel circuit 11b, the writing transistor M2 and the compensating transistor M3 are changed to the off state.

Further, as illustrated in FIG. 10, at the terminal point of the data period & the scanning select period, the voltage of the corresponding light emission control line Ej is changed from the high level to the low level. Therefore, in each of the R pixel circuit 11r, the G pixel circuit 11g, and the B pixel circuit 11b, the power-supplying transistor M5 and the light emission control transistor M6 are changed to the on state. Thus, the drive current I corresponding to the gate voltage Vg of the drive transistor M1 and the high-level power source line ELVDD, that is, the drive current I corresponding to the voltage held in the data-holding capacitor C1 is supplied to the organic EL element OLED, and the organic EL element OLED emits light in response to the current value of the drive current I. In this case, the organic EL element OLED in the R pixel circuit 11r emits red light, the organic EL element OLED in the G pixel circuit 11g emits green light, and the organic EL element OLED in the B pixel circuit 11b emits blue light. The drive current I is obtained by Equation (4) given above. The operation as described above is repeated n times during one frame period. With this, an image for one frame is displayed.

### 2.4 Effects

According to the present embodiment, similarly to the first embodiment described above, the data period including the data line charging period and the scanning select period during which the data-holding capacitor C1 in the pixel circuit 11 is charged overlap with each other (see “the data period & the scanning select period” in FIG. 10 and FIG. 11). With this, the data line charging period can be secured sufficiently. For example, in the waveform illustrated in FIG. 11, it is assumed that a display image has a resolution including the pixel number of 1080×1920 and the 1 H period is 8.18 μs, and when the time period from the starting point of the 1 H period to the starting point of the reset period is set to 1.5 μs, the reset period is set to 1.0 μs, and the interval between the on periods of the selecting transistors Mx (the interval between the periods during which the selection control signals SSDx are at the low level) is set to 0.4 μs (x=r. g, b), the data line charging period that lasts for 1.49 us can be secured even in the case of the SSD method in which each of the data signals that are output from the data-side drive circuit 30 is sequentially supplied to the three data signal lines Dri, Dgi, and Dbi by the demultiplexer 41, that is, the SSD method with multiplicity of three (hereinafter, referred to as a “3SSD method”).

Further, according to the present embodiment, similarly to the first embodiment described above, as illustrated in FIG. 11, the reset period is provided before the data period including the data line charging period (the data period & the scanning select period), and during the reset period, the white voltage is supplied as the reset voltage to each of the data signal lines Dxi (x=r, g, b). Thus, even when the data period and the scanning select period overlap with each other, the data writing failure caused by the diode-connection as illustrated in FIG. 17 does not occur.

Therefore, also in the present embodiment, while avoiding the data writing failure caused by the diode-connection, the data period and the scanning select period overlap with each other. In this manner, without reducing the scanning select period, the data line charging period can be increased to a larger extent compared to the related art. With this, in the organic EL display device adopting the 3SSD method, sufficient charging of the data voltage in the pixel circuit and sufficient internal compensation can be performed even when a display image has a higher resolution.

### 2.5 Modified Example in Second Embodiment

Also in the second embodiment described above, similarly to the modified example of the first embodiment described above (FIGS. 7), in consideration of a possibility that a difference in charging rate of the data-holding capacitor C1 is generated among the R pixel circuit 11r, the G pixel circuit 11g, and the B pixel circuit 11b, a configuration in which an order of the periods during which the R data signal line Dri, the G data signal line Dgi and the B data signal line Dbi are charged with the data voltages in each of the horizontal intervals (the 1 H periods) is switched for one or more predetermined frame periods is conceivable. Each of FIGS. 12A and 12B is a waveform diagram illustrating an operation of the display device according to the modified example of the second embodiment described above having such configuration, and illustrates waveforms of main signals for driving the pixel circuits 11r, 11g, and 11b illustrated in FIG. 9 during the 1 H period. Here, a description of the present modified example will be provided. Note that, among the configurations of the present modified example, parts similar to those in the second embodiment described above are denoted with the same reference symbols, and description thereof is omitted. Note that, in the following, the period during which the data line charging period with the R data signal, that is, the R selecting transistor Mr is in the on state and the R data signal is supplied to the R data signal line Dri is referred to a “R data line charging period,” the period during which the data line charging period with the G data signal, that is, the G selecting transistor Mg is in the on state and the G data signal is supplied to the G data signal line Dgi is referred to a “G data line charging period,” and the period during which the data line charging period with the B data signal, that is, the B selecting transistor Mb is in the on state and the B data signal is supplied to the B data signal line Dbi is referred to a “B data line charging period.”

In the present modified example, similarly to the second embodiment described above, the display control circuit 20 controls the demultiplexer unit 40 and the data-side drive circuit 30 such that, during each of the horizontal intervals (the 1 H periods) in the odd-numbered frames, the three data line charging periods corresponding to the data signal line groups in each set sequentially appear in the order of the R data line charging period, the G data line charging period, and the B data line charging period (see FIG. 12A), and that, during each of the horizontal intervals (the 1 H periods) in the even-numbered frames, the three data line charging periods corresponding to the data signal line groups in each set sequentially appear in the order of the B data line charging period, the G data line charging period, and the R data line charging period (see FIG. 12B). That is, the display control circuit 20 in the present modified example is configured to generate the data signals of the R selection control signal SSDr, the G selection control signal SSDG, and the B selection control signal SSDb, and the output line Di of the data-side drive circuit 30, which are illustrated in FIG. 12A or FIG. 12B, in accordance with the odd-numbered frames and the even-numbered frames. Note that, the data signal of the output line Di is generated by the data-side drive circuit 30 based on the display data DA and the like supplied from the display control circuit 20 to the data-side drive circuit 30.

According to the present modified example described above, the temporal positional relationship between the R data line charging period and the B data line charging period during each of the horizontal intervals is switched for one frame period, and hence even when a difference in charging rate of the data-holding capacitor C1 between the R pixel circuit 11r and the B pixel circuit 11b causes a difference in luminance, the luminance difference is balanced in a temporal manner, which is less visually recognizable to an observer. Therefore, the present modified example can exert effects similar to those in the second embodiment described above, and can suppress the luminance difference in a visual manner and improve display quality as compared to the second embodiment described above.

Note that, the present modified example, the temporal positional relationship between the R data line charging period and the B data line charging period in each of the horizontal intervals is switched for one frame period. However, in place of this, the temporal positional relationship among the R data line charging period, the G data line charging period, and the B data line charging period in each of the horizontal intervals may be switched cyclically for one frame period. According to the configuration described above, even when a luminance difference is caused due to a difference in charging rate of the data-holding capacitor C1 among the R pixel circuit 11r, the G pixel circuit 11g, and the B pixel circuit 11b, the luminance difference is balanced in three-frame-period unit in a temporal manner, which is less visually recognizable to an observer. As a result, display quality can further be improved.

### 3. Other Modified Examples

The disclosure is not limited to each of the embodiments described above, and various modifications can be made without departing from the scope of the disclosure.

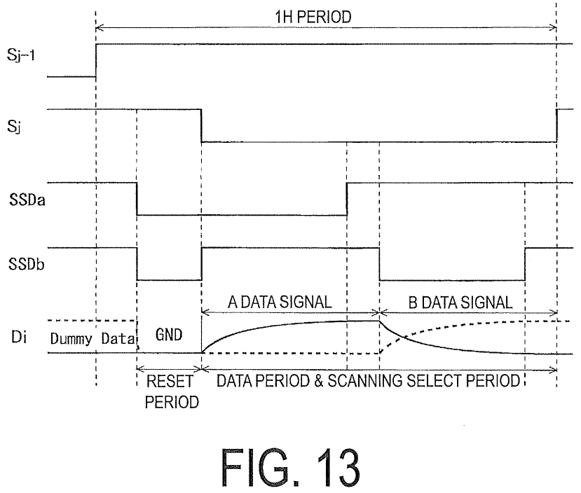

For example, in each of the embodiments described above, during the reset period provided for avoiding the data writing failure caused by the diode-connection (FIG. 17), the white voltage is applied as the reset voltage to each of the data signal lines Dxi (x=r, g, b or x=a, b). However, the reset voltage is not limited to the white voltage, and is only required to be the minimum voltage that the data signal line Dxi may have or a voltage less than the minimum voltage during the scanning select period. Further, in each of the embodiments described above, the corresponding data signal line Dxi corresponds to the anode side of the drive transistor M1 in the diode-connected state. However, in a case where the corresponding data signal line Dxi corresponds to the cathode side of the drive transistor M1 in the diode-connected state (a case where an orientation of the diode achieved by the drive transistor M1 in the diode-connected state is opposite to that in each of the embodiments described above by adopting another configuration in which, for example, an N-channel type transistor is used as the drive transistor M1 in the pixel circuit 11), the reset voltage is only required to be the maximum voltage that the data signal line may have or a voltage greater than the maximum voltage during the scanning select period. In a more general sense, the reset voltage is only required to be a voltage that initializes each of the data signal lines Dxi in order to be capable of charging the data-holding capacitor C1 via the drive transistor M1 in the diode-connected state in the pixel circuit 11x regardless of the voltage that the data voltage may have during the scanning select period. Therefore, the voltage that can be used as the initialization voltage Vini of the data-holding capacitor C1 can be used as the reset voltage. For example, in the organic EL display device having the configuration illustrated in FIG. 1 and FIG. 2, a voltage less than the minimum voltage that the voltage of the data signal may have during the scanning select period, for example, the low-level power source line ELVSS (<0) for driving the organic EL element may be a reset voltage. Further, for example, in the organic EL display device having the configuration illustrated in FIG. 1 and FIG. 2, a voltage of 0 V being a ground voltage (hereinafter, referred to as a “GND”) may be a reset voltage. In this case, the pixel circuits 11a and 11b in the configuration illustrated in FIG. 2 are driven by the signals illustrated in FIG. 13.

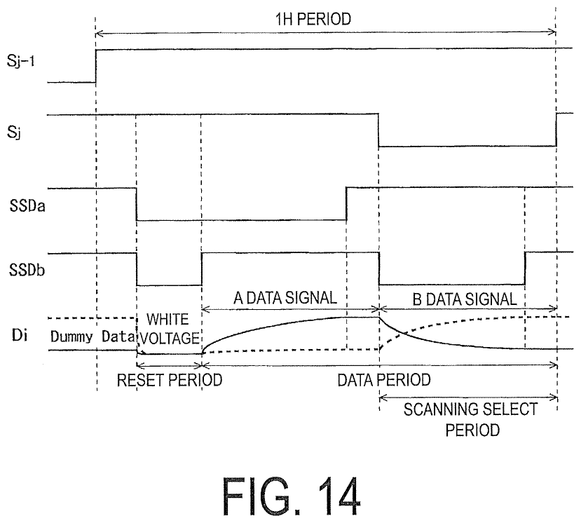

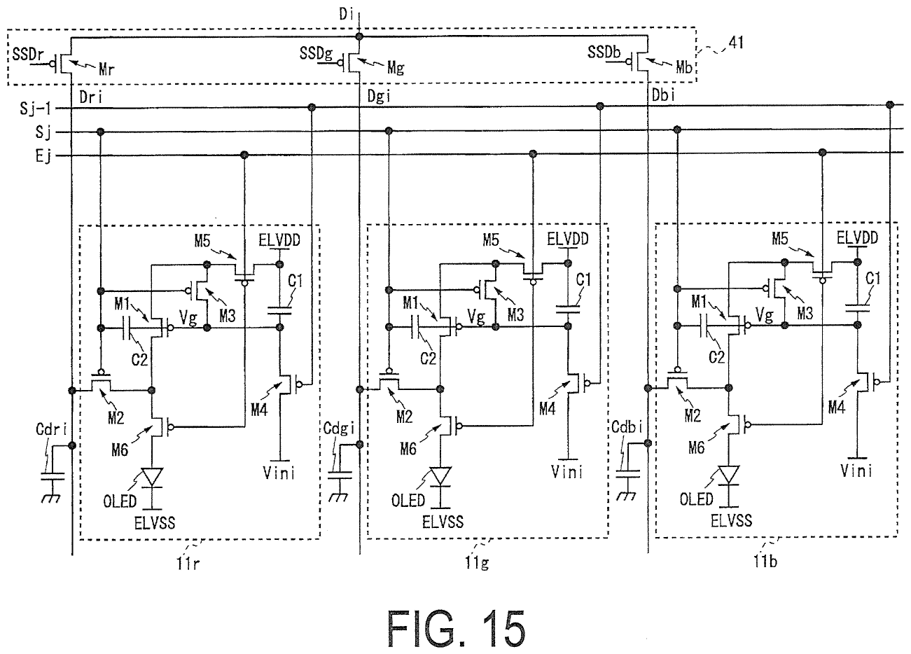

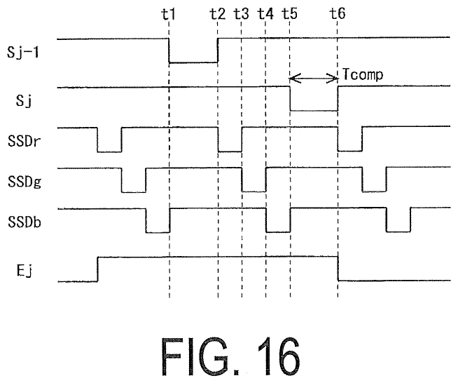

Further, in each of the embodiments described above, during the period during which the scanning signal line Sj is in the select state (the scanning select period), the selection control signals SSDx (x=a, b, or x=r, g, b) are generated such that all the data line charging periods (the X data line charging periods (X=A, B, or X=R, G, B) are included (see FIG. 6, FIG. 11, and the like). In place of this, the selection control signals SSDx may be configured to generated such that the period during which the scanning signal line Sj is in the select state (the scanning select period) overlaps with one or more data line charging periods (such that one or more selecting transistors Mx in each of the demultiplexers 41 are in the on state during the scanning select period). For example, in the organic EL display device having the configuration illustrated in FIG. 1 and FIG. 2, as illustrated in FIG. 14, after the A data line charging period during which the A selecting transistor Ma is in the on state (the period during which the A data signal is supplied to the A data signal line Dai) is terminated, the scanning signal line Sj may be in the select state, and during the select period for the scanning signal line Sj, only the B selecting transistor Mb may be in the on state such that the B data signal is supplied to the B data signal line Dbi. The configuration described above is effective for suppressing a luminance difference that may be caused by a difference in charging rate of the data-holding capacitor C1 between the A pixel circuit 11a and the B pixel circuit 11b.

Further, the SSD method with multiplicity of two is adopted in the first embodiment described above (FIG. 2), and the SSD method with multiplicity of three is adopted in the second embodiment described above (FIG. 9). However, the SSD method with multiplicity of four or more may be adopted. For example, in an organic EL display device that displays a color image based on four primary colors, the SSD method with multiplicity of four may be adopted, the method in which a plurality of data signal lines in the display unit are divided into m data signal line groups, each of which is a set of four data signal lines corresponding to the four primary colors. In this case, m demultiplexers are provided correspondingly to the m data signal line groups. Each of the demultiplexers includes four selecting transistors as switching elements, which are respectively connected to the four data signal lines in the corresponding group, and the four data signals (four analog voltage signals corresponding to the four primary colors), which are output in time division from each output terminal Tdi of the data-side drive circuit 30, are applied to the four data signal lines by the demultiplexer 41. In a more general sense, the multiplicity of the SSD method is only required to be a predetermined number being two or more, which is sufficiently smaller than the number of data signal lines disposed in the display unit 10. In a case that the SSD method in which multiplicity is a predetermined number of two or more is adopted, the plurality of data signal lines in the display unit are divided into the m data signal line groups, each of the m data signal line groups including the predetermined numbers of data signal lines, and the m demultiplexers 41 are provided correspondingly to the m data signal line groups. In this case, each of the demultiplexer 41 includes the predetermined number of selecting transistors as switching elements, which are respectively connected to the predetermined number of data signal lines in the corresponding group, and the predetermined number of data signals (the predetermined number of analog voltage signals) output in time division from each output terminal Tdi of the data-side drive circuit 30 are applied to the predetermined number of data signal lines by the demultiplexer 41.

Note that, in the description given above, the description of each of the embodiments and the modified examples by exemplifying the organic EL display device is provided. However, the disclosure is not limited to the organic EL display device, and is applicable to any display device adopting the SSD method using a display element driven by a current. The display element that can be used here is a display element having luminance, transmittance, or the like that is controlled by a current. For example, an inorganic light emitting diode, a Quantum dot Light Emitting Diode (QLED), and the like can be used in addition to an organic EL element, that is, an Organic Light Emitting Diode (OLED).

### 4. Supplement

### Supplement 1

A display device, including,

a plurality of data signal lines configured to transmit a plurality of analog voltage signals indicating an image to be displayed;

a plurality of scanning signal lines intersecting the plurality of data signal lines,

a plurality of pixel circuits arranged in a matrix shape along the plurality of data signal lines and the plurality of scanning signal lines,

wherein the display device further includes

a data-side drive circuit including a plurality of output terminals respectively corresponding to a plurality sets of data signal line groups that are obtained by dividing the plurality of data signal lines into groups, each of which is a set including a two or more predetermined number of data signal lines, configured to output, in time division from each of the plurality of output terminals, a predetermined number of analog voltage signals to be each transmitted by the predetermined number of data signal lines of a set corresponding to each of the output terminals;

a plurality of demultiplexers respectively connected to the plurality of output terminals of the data-side drive circuit, and respectively correspond to the plurality sets of data signal line groups,

a scanning-side drive circuit configured to selectively drive the plurality of scanning signal lines, and

a display control circuit configured to control the plurality of demultiplexers, the data-side drive circuit, and the scanning-side drive circuit,

each of the plurality of demultiplexers includes a predetermined number of switching elements respectively corresponding to the predetermined number of data signal lines in a corresponding set, respectively, and each of the predetermined number of switching elements includes a first conduction terminal connected to a corresponding data signal line, a second conduction terminal configured to receive an analog voltage signal output by the data-side drive circuit from an output terminal of the plurality of output terminals connected to a demultiplexer of the plurality of demultiplexers, and a control terminal configured to receive a selection control signal for controlling on and off states,

each of the plurality of pixel circuits corresponds to any one of the plurality of data signal lines and corresponds to any one of the plurality of scanning signal lines,

each of the plurality of pixel circuits includes a display element configured to be driven by a current, a holding capacitance configured to hold a voltage for controlling a drive current for the display element, and a drive transistor configured to supply, to the display element, the drive current in accordance with the voltage held in the holding capacitance, and is configured such that in a case that a corresponding scanning signal line is in a select state, the drive transistor is in a diode-connected state, and a voltage of a corresponding data signal line is supplied to the holding capacitance via the drive transistor,

the display control circuit

simultaneously turns the predetermined number of switching elements to an on state during a reset period provided, for a scanning signal line of the plurality of scanning signal lines, after a preceding scanning signal line is changed to a non-select state and before the scanning signal line is selected, the preceding scanning signal line being another scanning signal line of the plurality of scanning signal lines selected immediately before the scanning signal line is selected, and

sequentially turns the predetermined number of switching elements to the on state for a predetermined period after the reset period and before the scanning signal line is changed from the select state to the non-select state such that at least one switching element of the predetermined number of switching elements turns to the on state during a select period for each of the plurality of scanning signal lines, and

the data-side drive circuit

during the reset period, outputs a voltage for initializing each of the plurality of data signal lines as a reset voltage from each of the plurality of output terminals, and

after the reset period, outputs the predetermined number of analog voltage signals in time division from each of the plurality of output terminals in accordance with control of the display control circuit that sequentially turns the predetermined number of switching elements to the on state for the predetermined period.

### Supplement 2

In the display device described in Supplement 1, the display control circuit may sequentially turn the predetermined number of switching elements to the on state for the predetermined period during a select period for each of the plurality of scanning signal lines.

According to the display device described in Supplement 2, during each of the select periods for the plurality of scanning signal lines in the display unit, the predetermined number of switching elements in each of the demultiplexers sequentially turn to the on state, and in accordance with this, the predetermined number of analog voltage signals are output in time division from each of the output terminals of the data-side drive circuit. With this, while avoiding the data writing failure caused by the diode-connection in the pixel circuit, the data line charging period can be increased to a larger extent, and the select period can be increased to a larger extent as compared to the related art. With this, sufficient charging of the data voltage and sufficient internal compensation in the pixel circuit can be performed even in a case that a display image has a higher resolution.

### Supplement 3

In the display device described in Supplement 2, the display control circuit may change the order of turning the predetermined number of switching elements to the on state for the predetermined period for one or more frame periods.

According to the display device described in Supplement 3, the order in which the predetermined number of switching elements in each of the demultiplexers is changed for one or more frame periods. With this, even when a luminance difference is generated due to a difference in charging rate of the holding capacitance between the pixel circuits connected to different data signal lines among the predetermined number of data signal lines corresponding to each of the demultiplexers, the luminance difference is balanced in a temporal manner, which is less visually recognizable to an observer. Therefore, in addition to the effects similar to those in the display device described in Supplement 2, an effect of suppressing the luminance difference visually and improving display quality can be obtained.

### Supplement 4

In the display device described in Supplement 1 or 2, the plurality of data signal lines may be configured to transmit a plurality of analog voltage signals indicating a color image based on three or more predetermined number of primary colors, each of the plurality of data signal lines may be correspond to any one of the three or more predetermined number of primary colors, the plurality sets of data signal groups may be obtained by dividing the plurality of data signal lines into groups, each of which is a set including a predetermined number of data signal lines corresponding to the three or more predetermined number of primary colors, and the plurality of pixel circuits may be configured to display the color image on the basis of the plurality of analog voltage signals.

According to the display device described in Supplement 4, the plurality of data signal lines in the display unit transmit the plurality of analog voltage signals indicating the color image based on the three or more predetermined number of primary colors, and are divided into the plurality sets of data signal line groups, each of which is a set including the predetermined number of data signal lines corresponding to the predetermined number of primary colors. The analog voltage signals, which are output in time division from each output terminal of the data-side drive circuit, are sequentially supplied to the predetermined number of data signal lines in the set corresponding to the output terminal. In the display device configured to display a color image with the SSD method, the similar effects can be obtained on the basis of the similar characteristics of the display device described in Supplement 1 or 2.

### Supplement 5

In the display device described in Supplement 4, the display control circuit may change the order of turning the predetermined number of switching elements to the on state for the predetermined period for one or more frame periods.

According to the display device described in Supplement 5, similarly to the display device described in Supplement 3, even when a luminance difference is generated due to a difference in charging rate of the holding capacitance between the pixel circuits connected to different data signal lines among the predetermined number of data signal lines corresponding to each of the demultiplexers, the luminance difference is balanced in a temporal manner, which is less visually recognizable to an observer. Therefore, in addition to the effects similar to those in the display device described in Supplement 4, an effect of suppressing the luminance difference visually and improving display quality can be obtained.

### Supplement 6

In the display device described in any one of Supplements 1 to 5, the plurality of pixel circuits may be each configured such that a data signal line corresponding to a pixel circuit of the plurality of pixel circuits corresponds to an anode side of a drive transistor in the diode-connected state in the pixel circuit, and, in a case that any of the plurality of scanning signal lines is in the select state, the data-side drive circuit may be configured to output, from each of the plurality of output terminals, an allowable minimum voltage of each of the plurality of data signal lines or a voltage less than the allowable minimum voltage as a reset voltage during the reset period.

According to the display device described in Supplement 6, each of the pixel circuits is configured such that the data signal line corresponding to a pixel circuit of the plurality of pixel circuits corresponds to the anode side of the drive transistor in the diode-connected state in the pixel circuit, and, in a case that any of the plurality of scanning signal lines in the display unit is in the select state, the allowable minimum voltage of each of the plurality of data signal lines or the voltage less than the allowable minimum voltage is supplied as the reset voltage to each of the plurality of the data signal lines during the reset period. With this, even when the data period and the scanning select period overlap with each other, the data writing failure caused by the diode-connection in the pixel circuit does not occur.

### Supplement 7

In the display device described in any one of Supplements 1 to 5, the plurality of pixel circuits may be configured such that a data signal line corresponding to a pixel circuit of the plurality of pixel circuits corresponds to a cathode side of the drive transistor in the diode-connected state in the pixel circuit, and in case that any of the plurality of scanning signal lines is in the select state, the data-side drive circuit may be configured to output, from each of the plurality of output terminals, an allowable maximum voltage of each of the plurality of data signal lines or a voltage greater than the allowable maximum voltage as a reset voltage during the reset period.

According to the display device described in Supplement 7, each of the pixel circuits is configured such that the data signal line corresponding to a pixel circuit of the plurality of pixel circuits corresponds to the cathode side of the drive transistor in the diode-connected state in the pixel circuit, and in case that any of the plurality of scanning signal lines in the display unit is in the select state, the allowable maximum voltage of each of the plurality of data signal lines or the voltage greater than the allowable maximum voltage is supplied as the reset voltage to each of the plurality of the data signal lines during the reset period. With this, even when the data period and the scanning select period overlap with each other, the data writing failure caused by the diode-connection in the pixel circuit does not occur.

### REFERENCE SIGNS LIST

1, 2 Display device
10 Display unit
11, 11x Pixel circuit (x=a, b or x=r, g, b)
20 Display control circuit
30 Data-side drive circuit
40 Demultiplexer unit
41 Demultiplexer
50 Scanning-side drive circuit
60 Light emission control line drive circuit
Tdi Output terminal (i=1 to m)
Di Output line (i=1 to m)
Dai, Dbi Data signal line
Dri, Dgi, Dbi Data signal line
Sj Scanning signal line (j=1 to n)
Ej Light emission control line (j=1 to n)
Cdai, Cdbi Data line capacitance (i=1 to m)
Cdri, Cdgi, Cdbi Data line capacitance (i=1 to m)
Ma, Mb Selecting transistor (switching element)
Mr, Mg, Mb Selecting transistor (switching element)
M1 Drive transistor
M2 Writing transistor
M3 Compensating transistor
M4, M7 Initialization transistor
M5 Power-supplying transistor
M6 Light emission control transistor
C1 Data-holding capacitor (holding capacitance)
SSDx Selection control signal (x=a, b or x=r, g, b)

1. A display device, comprising:
a plurality of data signal lines configured to transmit a plurality of analog voltage signals indicating an image to be displayed;
a plurality of scanning signal lines intersecting the plurality of data signal lines;
a plurality of pixel circuits arranged in a matrix shape along the plurality of data signal lines and the plurality of scanning signal lines,
wherein the display device further includes
a data-side drive circuit including a plurality of output terminals respectively corresponding to a plurality sets of data signal line groups that are obtained by dividing the plurality of data signal lines into groups, each of which is a set including a two or more predetermined number of data signal lines, configured to output, in time division from each of the plurality of output terminals, a predetermined number of analog voltage signals to be each transmitted by the predetermined number of data signal lines of a set corresponding to each of the output terminals,
a plurality of demultiplexers respectively connected to the plurality of output terminals of the data-side drive circuit, and respectively correspond to the plurality sets of data signal line groups,
a scanning-side drive circuit configured to selectively drive the plurality of scanning signal lines, and
a display control circuit configured to control the plurality of demultiplexers, the data-side drive circuit, and the scanning-side drive circuit,
each of the plurality of demultiplexers includes a predetermined number of switching elements respectively corresponding to the predetermined number of data signal lines in a corresponding set, respectively, and each of the predetermined number of switching elements includes a first conduction terminal connected to a corresponding data signal line, a second conduction terminal configured to receive an analog voltage signal output by the data-side drive circuit from an output terminal of the plurality of output terminals connected to a demultiplexer of the plurality of demultiplexers, and a control terminal configured to receive a selection control signal for controlling on and off states,
each of the plurality of pixel circuits corresponds to any one of the plurality of data signal lines and corresponds to any one of the plurality of scanning signal lines,
each of the plurality of pixel circuits includes a display element configured to be driven by a current, a holding capacitance configured to hold a voltage for controlling a drive current for the display element, and a drive transistor configured to supply, to the display element, the drive current in accordance with the voltage held in the holding capacitance, and is configured such that in a case that a corresponding scanning signal line is in a select state, the drive transistor is in a diode-connected state, and a voltage of a corresponding data signal line is supplied to the holding capacitance via the drive transistor,
the display control circuit
simultaneously turns the predetermined number of switching elements to an on state during a reset period provided, for a scanning signal line of the plurality of scanning signal lines, after a preceding scanning signal line is changed to a non-select state and before the scanning signal line is selected, the preceding scanning signal line being another scanning signal line of the plurality of scanning signal lines selected immediately before the scanning signal line is selected, and
sequentially turns the predetermined number of switching elements to the on state for a predetermined period after the reset period and before the scanning signal line is changed from the select state to the non-select state such that at least one switching element of the predetermined number of switching elements turns to the on state during a select period for each of the plurality of scanning signal lines, and
the data-side drive circuit
during the reset period, outputs a voltage for initializing each of the plurality of data signal lines as a reset voltage from each of the plurality of output terminals, and
after the reset period, outputs the predetermined number of analog voltage signals in time division from each of the plurality of output terminals in accordance with control of the display control circuit that sequentially turns the predetermined number of switching elements to the on state for the predetermined period.

2. The display device according to claim 1,
wherein the display control circuit sequentially turns the predetermined number of switching elements to the on state for the predetermined period during a select period for each of the plurality of scanning signal lines.

3. The display device according to claim 2,
wherein the display control circuit changes an order of turning the predetermined number of switching elements to the on state for the predetermined period for one or more frame periods.

4. The display device according to claim 1,
wherein the plurality of data signal lines are configured to transmit a plurality of analog voltage signals indicating a color image based on three or more predetermined number of primary colors, and each of the plurality of data signal lines corresponds to any one of the three or more predetermined number of primary colors,
the plurality sets of data signal groups are obtained by dividing the plurality of data signal lines into groups, each of which is a set including a predetermined number of data signal lines corresponding to the three or more predetermined number of primary colors, and
the plurality of pixel circuits are configured to display the color image on the basis of the plurality of analog voltage signals.

5. The display device according to claim 4,
wherein the display control circuit changes an order of turning the predetermined number of switching elements to the on state for the predetermined period for one or more frame periods.

6. The display device according to claim 1,
wherein the plurality of pixel circuits are each configured such that a data signal line corresponding to a pixel circuit of the plurality of pixel circuits corresponds to an anode side of a drive transistor in the diode-connected state in the pixel circuit, and
in a case that any of the plurality of scanning signal lines is in the select state, the data-side drive circuit is configured to output, from each of the plurality of output terminals, an allowable minimum voltage of each of the plurality of data signal lines or a voltage less than the allowable minimum voltage as a reset voltage during the reset period.

7. The display device according to claim 1,
wherein the plurality of pixel circuits are configured such that a data signal line corresponding to a pixel circuit of the plurality of pixel circuits corresponds to a cathode side of the drive transistor in the diode-connected state in the pixel circuit, and
in a case that any of the plurality of scanning signal lines is in the select state, the data-side drive circuit is configured to output, from each of the plurality of output terminals, an allowable maximum voltage of each of the plurality of data signal lines or a voltage greater than the allowable maximum voltage as a reset voltage during the reset period.

8. A driving method of a display device including
a plurality of data signal lines configured to transmit a plurality of analog voltage signals indicating an image to be displayed,
a plurality of scanning signal lines intersecting the plurality of data signal lines, and
a plurality of pixel circuits arranged in a matrix shape along the plurality of data signal lines and the plurality of scanning signal lines,
the display device further including
a data-side drive circuit including a plurality of output terminals respectively corresponding to a plurality sets of data signal line groups that are obtained by dividing the plurality of data signal lines into groups, each of which is a set including a two or more predetermined number of data signal lines, and
a plurality of demultiplexers respectively connected to the plurality of output terminals of the data-side drive circuit and corresponding to the plurality sets of data signal line groups, respectively,
each of the plurality of demultiplexers including a predetermined number of switching elements corresponding to the predetermined number of data signal lines in the corresponding set, respectively, each of the predetermined number of switching elements including a first conduction terminal connected to a corresponding data signal line, a second conduction terminal configured to receive an analog voltage signal output from an output terminal of the plurality of output terminals connected to a demultiplexer of the plurality of demultiplexers, and a control terminal configured to receive a selection control signal for controlling on and off states,
each of the plurality of pixel circuits corresponding to any one of the plurality of data signal lines and corresponding to any one of the plurality of scanning signal lines,
each of the plurality of pixel circuits including a display element configured to be driven by a current, a holding capacitance configured to hold a voltage for controlling a drive current for the display element, and a drive transistor configured to supply, to the display element, the drive current in accordance with the voltage held in the holding capacitance, and being configured such that in a case that a corresponding scanning signal line is in a select state, the drive transistor is in a diode-connected state, and a voltage is supplied from the corresponding data signal line to the holding capacitance via the drive transistor,
the method comprising:
a scanning-side driving step of selectively driving the plurality of scanning signal lines;
a reset step of simultaneously turning the predetermined number of switching elements to an on state during a reset period provided, for a scanning signal line of the plurality of scanning signal lines, after a preceding scanning signal line is changed to a non-select state and before the scanning signal line is selected, the preceding scanning signal line being another scanning signal line of the plurality of scanning signal lines selected immediately before the scanning signal line is selected;
a demultiplex step of sequentially turning the predetermined number of switching elements to the on state for a predetermined period after the reset period and before the scanning signal line is changed from the select state to the non-select state such that at least one switching element of the predetermined number of switching elements is the on state during a select period for each of the plurality of scanning signal lines;
a reset voltage output step of outputting a voltage for initializing each of the data signal lines as a reset voltage from each of the plurality of output terminals of the data-side driver circuit during the reset period; and
a data signal output step of outputting, in time division from each of the plurality of output terminals of the data-side drive circuit, the predetermined number of analog voltage signals to be transmitted to the predetermined number of data signal lines in the set corresponding to each of the plurality of output terminals after the reset period, in accordance with the demultiplex step of sequentially turning the predetermined number of switching elements to the on state for the predetermined period.

9. The driving method according to claim 8,
wherein, in the demultiplex step, the predetermined number of switching elements sequentially turn to the on state for the predetermined period during a select period for each of the plurality of scanning signal lines.

10. The driving method according to claim 9,
wherein, in the demultiplex step, an order of turning the predetermined number of switching elements to the on state for the predetermined period is changed for one or more frame periods.
